(19) United States
(12) Patent Application Publication
(10) Pub. No.: US 2025/0299435 A1
(43) Pub. Date: Sep. 25, 2025

(54) VIRTUAL RAY PROCESSING

(71) Applicant: Tencent Technology (Shenzhen) Company Limited, Shenzhen (CN)

(72) Inventor: Huilong LIU, Shenzhen (CN)

(73) Assignee: Tencent Technology (Shenzhen) Company Limited, Shenzhen, GD (CN)

(21) Appl. No.: 19/231,405

(22) Filed: Jun. 6, 2025

Related U.S. Application Data
(63) Continuation of application No. PCT/CN2024/081856, filed on Mar. 15, 2024.

(30) Foreign Application Priority Data
May 23, 2023 (CN) 202310589460.1

(51) Int. Cl. G06T 15/50; G06T 15/06

(52) U.S. Cl. CPC G06T 15/506; G06T 15/06

(57) ABSTRACT

In a virtual ray processing method, a light source position of a virtual light source in a virtual scene and at least one light source parameter of the virtual light source is obtained. A target position in the virtual scene that is illuminated by the virtual light source is determined based on the light source position. A target size of a virtual mask is determined based on the at least one light source parameter and the target position. The virtual mask includes at least one transparent channel arranged according to an arrangement rule. The virtual light source is controlled to illuminate the virtual mask. A subset of the plurality of virtual rays passes through the at least one transparent channel to form the light pattern corresponding to the arrangement rule of the at least one transparent channel in the virtual mask.

### RELATED APPLICATIONS

The present application is a continuation of International Application No. PCT/CN2024/081856, filed on Mar. 15, 2024, which claims priority to Chinese Patent Application No. 202310589460.1, filed on May 23, 2023. The entire disclosures of the prior applications are hereby incorporated by reference.

### FIELD OF THE TECHNOLOGY

This application relates to the field of computer technologies, including a virtual ray processing method.

### BACKGROUND OF THE DISCLOSURE

With the rapid development of virtual reality technologies, production of virtual scenes is becoming increasingly diversified. To provide realistic virtual reality experience for a player, in an application supporting a virtual scene, to enhance expressiveness in the virtual scene, a lighting effect needs to be added to a rendering process.

In related art, since virtual projection is used when graphic is projected, during projection of some objects or components by some versions of software, a problem that the graphic is incorrect or even a projection is missing may occur. Consequently, there is a large limitation to a version requirement of a running environment in the related art.

### SUMMARY

Aspects of this disclosure provide a virtual ray processing method, an apparatus, and a non-transitory computer-readable storage medium, to more effectively improve universality of a running environment for processing a virtual ray.

Examples of technical solutions of this disclosure may be implemented as follows:

An aspect of this disclosure provides a virtual ray processing method. In the method, a light source position of a virtual light source in a virtual scene and at least one light source parameter of the virtual light source are obtained. The virtual light source emits a plurality of virtual rays in the virtual scene. A target position in the virtual scene that is illuminated by the virtual light source is determined based on the light source position. A target size of a virtual mask is determined based on the at least one light source parameter and the target position. The virtual mask is configured to block at least a portion of the plurality of virtual rays to generate a light pattern. The virtual mask with the target size is generated at the target position in the virtual scene. The virtual mask includes at least one transparent channel arranged according to an arrangement rule. The virtual light source is controlled to illuminate the virtual mask. A subset of the plurality of virtual rays passes through the at least one transparent channel to form the light pattern corresponding to the arrangement rule of the at least one transparent channel in the virtual mask.

An aspect of this disclosure provides a virtual ray processing apparatus, including processing circuitry. The processing circuitry is configured to obtain a light source position of a virtual light source in a virtual scene and at least one light source parameter of the virtual light source. The virtual light source emits a plurality of virtual rays in the virtual scene. The processing circuitry is configured to determine a target position in the virtual scene that is illuminated by the virtual light source based on the light source position. The processing circuitry is configured to determine a target size of a virtual mask based on the at least one light source parameter and the target position. The virtual mask is configured to block at least a portion of the plurality of virtual rays to generate a light pattern. The processing circuitry is configured to generate the virtual mask with the target size at the target position in the virtual scene. The virtual mask includes at least one transparent channel arranged according to an arrangement rule. The processing circuitry is configured to control the virtual light source to illuminate the virtual mask. A subset of the plurality of virtual rays passes through the at least one transparent channel to form the light pattern corresponding to the arrangement rule of the at least one transparent channel in the virtual mask.

An aspect of this disclosure provides a virtual ray processing method, including obtaining a light source position of a virtual light source configured to form a virtual ray in a virtual scene and a light source parameter of the virtual light source; determining a target position in the virtual scene based on the light source position, a connection line between the target position and the virtual light source coinciding with a central virtual ray, and the central virtual ray being a central virtual ray in a plurality of virtual rays emitted by the virtual light source; determining a target size of a virtual obstruction based on the light source parameter and the target position, the virtual obstruction being configured to block the virtual ray emitted by the virtual light source; generating the virtual obstruction with the target size at the target position in the virtual scene, at least one transparent channel arranged according to an arrangement rule being set on the virtual obstruction; and controlling the virtual light source to illuminate the virtual obstruction, to cause the virtual ray emitted by the virtual light source to pass through the transparent channel, and form graphics satisfying the arrangement rule in the virtual scene.

An aspect of this disclosure provides a virtual ray processing apparatus, including: an obtaining module, configured to obtain a light source position of a virtual light source configured to form a virtual ray in a virtual scene and a light source parameter of the virtual light source; a position determining module, configured to determine a target position in the virtual scene based on the light source position, a connection line between the target position and the virtual light source coinciding with a central virtual ray, and the central virtual ray being a central virtual ray in a plurality of virtual rays emitted by the virtual light source; a size determining module, configured to determine a target size of a virtual obstruction based on the light source parameter and the target position, the virtual obstruction being configured to block the virtual ray emitted by the virtual light source; a generation module, configured to generate the virtual obstruction with the target size at the target position in the virtual scene, at least one transparent channel arranged according to an arrangement rule being set on the virtual obstruction; and a control module, configured to control the virtual light source to illuminate the virtual obstruction, to cause a virtual ray emitted by the virtual light source to pass through the transparent channel, and form graphics satisfying the arrangement rule in the virtual scene.

An aspect of this disclosure provides an electronic device, including: a memory, configured to store computer-executable instructions or a computer program; and a processor, configured to implement, when executing the computer-executable instructions or the computer program stored in the memory, the virtual ray processing method provided in the aspects of this disclosure.

An aspect of this disclosure provides a non-transitory computer-readable storage medium, having computer-executable instructions stored therein, the computer-executable instructions, when executed by a processor, cause the processor to implement the virtual ray processing method provided in the aspects of this disclosure.

An aspect of this disclosure provides a computer program product, including a computer program or computer-executable instructions, and the computer program or the computer-executable instructions are stored in a computer-readable storage medium. A processor of an electronic device reads the computer-executable instructions from the computer-readable storage medium, and executes the computer-executable instructions, to enable the electronic device to perform the virtual ray processing method provided in the aspects of this disclosure.

Aspects of this disclosure have the following beneficial effects.

A light source position and a light source parameter of a virtual light source are obtained, a target size of a virtual obstruction is determined based on the light source position and the light source parameter, the virtual obstruction with the target size is generated at a target position in a virtual scene, and the virtual light source is controlled to illuminate the virtual obstruction, so that a virtual ray emitted by the virtual light source passes through a transparent channel, to form graphics satisfying an arrangement rule in the virtual scene. In this way, the virtual obstruction with the target size is placed at the target position in the virtual scene through physical parameters in the virtual scene such as the light source position and the light source parameter in the virtual scene. Because the virtual obstruction is provided with the transparent channel arranged according to the arrangement rule, the virtual obstruction placed at the target position can selectively block the virtual ray, to form the graphics satisfying the arrangement rule in the virtual scene. The placed virtual obstruction can satisfy a blocking requirement of the virtual ray, and corresponding physical parameters of the virtual scene are unchanged in different running environments, so that the placed virtual obstruction can be applicable to different running environments, thereby more effectively improving universality of a running environment for processing a virtual ray.

### BRIEF DESCRIPTION OF THE DRAWINGS

FIG. 1 is a schematic architectural diagram of a virtual ray processing system according to an aspect of this disclosure.

FIG. 2 is a schematic structural diagram of an electronic device configured to process a virtual ray according to an aspect of this disclosure.

FIG. 3 is a schematic flowchart 1 of a virtual ray processing method according to an aspect of this disclosure.

FIG. 4 is a schematic flowchart 2 of a virtual ray processing method according to an aspect of this disclosure.

FIG. 5 is a schematic flowchart 3 of a virtual ray processing method according to an aspect of this disclosure.

FIG. 6 is a schematic flowchart 4 of a virtual ray processing method according to an aspect of this disclosure.

FIG. 7 is a schematic principle diagram 1 of a virtual ray processing method according to an aspect of this disclosure.

FIG. 8 is a schematic principle diagram 1 of a two-dimensional virtual obstruction according to an aspect of this disclosure.

FIG. 9 is a schematic principle diagram 2 of a two-dimensional virtual obstruction according to an aspect of this disclosure.

FIG. 10 is a schematic principle diagram 2 of a virtual ray processing method according to an aspect of this disclosure.

FIG. 11 is a schematic effect diagram of a three-dimensional virtual obstruction according to an aspect of this disclosure.

FIG. 12 is a schematic principle diagram 1 of a two-dimensional virtual obstruction according to an aspect of this disclosure.

FIG. 13 is a schematic principle diagram of a three-dimensional virtual obstruction according to an aspect of this disclosure.

FIG. 14 is a schematic effect diagram of a virtual ray processing method according to an aspect of this disclosure.

FIG. 15 is a schematic flowchart 5 of a virtual ray processing method according to an aspect of this disclosure.

FIG. 16 is a schematic flowchart 6 of a virtual ray processing method according to an aspect of this disclosure.

FIG. 17 is a schematic principle diagram of a cuboid in a virtual ray processing method according to an aspect of this disclosure.

FIG. 18 is a schematic principle diagram 3 of a virtual ray processing method according to an aspect of this disclosure.

FIG. 19 is a schematic flowchart 7 of a virtual ray processing method according to an aspect of this disclosure.

### DETAILED DESCRIPTION

To make the objectives, technical solutions, and advantages of this disclosure clearer, the following describes this disclosure in further detail with reference to the accompanying drawings. The described aspects are not to be considered as a limitation to this disclosure. All other aspects obtained by a person of ordinary skill in the art shall fall within the scope of this disclosure. Further, the descriptions of the terms are provided as examples only and are not intended to limit the scope of the disclosure.

In the following descriptions, “some aspects” describe a subset of all possible aspects. However, the “some aspects” may be the same subset or different subsets of all the possible aspects, and may be combined with each other without conflict.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The terms, involved in the following descriptions, “first/second/third” are merely intended to distinguish between similar objects rather than describing specific orders. The “first/second/third” is interchangeable in proper circumstances to enable the aspects of this disclosure to be implemented in other orders than those illustrated or described herein.

Unless otherwise defined, meanings of all technical and scientific terms used herein are the same as those usually understood by a person skilled in the art to which this disclosure belongs. Terms used herein are merely intended to describe examples of the aspects of this disclosure, and are not intended to limit this disclosure.

Before the aspects of this disclosure are described in further detail, terms involved in the aspects of this disclosure are described. The terms involved in the aspects of this disclosure are applicable to the following explanations.

(1) In response to: It is configured for representing a condition or a status on which an operation to be performed depends. When the condition or the status on which the operation depends is met, one or more performed operations may be in real time or may have a set delay. Unless otherwise specified, there is no restriction on an order of performing a plurality of performed operations.

(2) Virtual scene: It is a virtual scene displayed or provided when an application is run on a terminal. The virtual scene may be a simulated environment of the real world, or may be a semi-simulated and semi-fictional virtual environment, or may be a fictional virtual environment. The virtual scene may be any one of a two-dimensional virtual scene, a 2.5-dimensional virtual scene, or a three-dimensional virtual scene. The aspects of this disclosure do not limit the dimension of the virtual scene. For example, the virtual scene may include the sky, the land, the ocean, or the like. The land may include environmental elements such as the desert and a city. A user may control the virtual object to move in the virtual scene.

(3) Virtual object: It is an image of various people and articles that can be interacted with in the virtual scene, or a movable object in the virtual scene. The movable object may be a virtual person, a virtual animal, a cartoon person, or the like, for example, a person, an animal, a plant, an oil barrel, a wall, or a rock displayed in the virtual scene. The virtual object may be a virtual image configured for representing the user in the virtual scene. The virtual scene may include a plurality of virtual objects, and each virtual object has a shape and a volume in the virtual scene, and occupies some space in the virtual scene. The virtual object may be a user character controlled through an operation performed on a client, or artificial intelligence (AI) set in a battle in the virtual scene through training, or a non-player character (NPC) set in interaction in the virtual scene. The virtual object may be a virtual person for adversarial interaction in the virtual scene. A quantity of virtual objects participating in the interaction in the virtual scene may be preset or dynamically determined based on a quantity of clients participating in the interaction.

(4) Game program: The game program may be any one of a massively multiplayer online role-playing game (MMORPG), a first-person shooting (FPS) game, a third-person shooting game, a multiplayer online battle arena (MOBA) game, a virtual reality application, a three-dimensional map program, a simulation program, or a multiplayer gunfight survival game.

(5) Augmented reality (AR): It is a technology that skillfully integrates virtual information with the real world. It simulates computer-generated virtual information such as text, images, three-dimensional models, music, and videos by extensively using a variety of technical means such as multimedia, three-dimensional modeling, real-time registration, intelligent interaction, and sensing, and then applies the virtual information to the real world. Two types of information complement each other to “augment” the real world. The augmented reality technology is also referred to as augmented reality. The AR technology is a new technology that integrates real-world information and virtual-world information content. It simulates and processes physical information that was originally difficult to experience in the spatial scope of the real world based on computers and other scientific technologies, and effectively applies virtual information content in the real world. In addition, in the process, the virtual information content can be perceived by human senses, thereby achieving a sensory experience beyond reality. After a real environment and a virtual item overlap, the real environment and the virtual item can exist in a same image and space at the same time.

(6) Virtual camera: It is a “video camera” set up in computer animation software or a virtual engine. A function of the virtual camera in expressing viewpoints during animation is equivalent to a conventional video camera. Subjects of the virtual camera and a physical camera are different, but functions are extremely similar. The physical camera shoots real people or an actually built scene, and the virtual camera shoots a model built in three-dimensional software, which can achieve unlimited possibilities. The virtual camera is presented in a form of an icon in the virtual engine, and also have parameters such as a lens, a focal length, a focus, an aperture, and a depth of field. The virtual camera can implement camera actions such as “push, pull, shake, move, follow, swing, rise, fall, and comprehensive movement”, and can achieve shooting effects that are difficult or even impossible to achieve for the physical camera, such as: passing through a wall, passing through a key hole, and passing through an item. Parameters of the physical camera that need to be adjusted are distributed on a body of the physical camera and need to be manually operated. A camera parameter of the virtual camera is a button or a value input bar integrated on a panel. An operator only needs to enter a parameter or drag a mouse, and sometimes a motion path of the virtual camera may be determined through several key frames. During actual shooting, the physical camera usually needs a stabilizer or a motion control system, even in this way, shake of a picture still exists.

(7) Virtual engine: The virtual engine may refer to core components of some

editable computer virtual systems or some interactive real-time image applications that have been written. The systems provide various tools required for writing a virtual scene for a designer of the virtual scene, and aim at enabling the designer to easily and quickly write a program. The virtual engine includes a rendering engine (where the rendering engine includes a two-dimensional rendering engine and a three-dimensional rendering engine), a physical engine, a collision detection engine, a sound effect engine, a script engine, an animation engine, an artificial intelligence engine, a network engine, a scene management engine, and the like.

(8) Virtual light source: It is a “light source” set up in the computer animation software or the virtual engine. A function of the virtual light source for expressing viewpoints during animation production is equivalent to a conventional physical light source. Objects illuminated by the virtual light source are totally different from objects illuminated by the physical light source, but functions are extremely similar. The physical light source illuminates real people or an actually built scene, and the virtual light source illuminates a model built in the three-dimensional software, which can implement unlimited possibilities.

(9) Virtual ray: It is a ray in a virtual scene emitted by the virtual light source configured to illuminate the virtual scene. The virtual ray includes a direct ray and an indirect ray. The direct ray is a virtual ray emitted by the virtual light source and reflected to the virtual camera by a virtual illumination point. The indirect ray is a virtual ray emitted by the virtual light source to a virtual illumination point after being reflected at least once, and finally reflected to the virtual camera by the virtual illumination point.

(10) Virtual production: The virtual production is broad term, and may refer to a series of computer-assisted film production and visual film production methods. Some common definitions of the virtual production are first described. According to the definition of Weta Digital, “Virtual production is where the physical and digital worlds meet.” The virtual production combines virtual reality and augmented reality with computer-generated imagery (CGI) and game engine technologies, so that production personnel can see that scenes are expanded in front of them, as if the scenes are synthesized and shot in a real scene.

(11) Digital multiplex (DMX) light: Actually, the DMX light is a device responsible for receiving and executing a command based on received data. This may mean turning on or turning off a light source or rotating the device by 90 degrees. There are many types of DMX lights, ranging from a standard stage light with a simple switch to an intelligent light that can rotate in multiple directions and has an optical filter. Each light has a group of predefined attributes/commands at a hardware level. The attributes are classified into groups named odes. Many lights include multiple modes, and the modes predefine an available attribute to which the light is to respond. A light manufacturer provides different mode options for the user, so that the user can adapt to various use cases, as many functions as possible are included, and the user is allowed to select a function most important to the user. In this way, a simplest and smallest channel counting mode is formed; a complex and massive channel mode is formed; and some intermediate modes are formed. In professional illumination practice, an intermediate mode is selected at many times, to balance a function and case of control and use a number of DMX channels more economically. Each mode includes a group of attributes. The attribute is responsible for informing hardware how to respond to received DMX data. In most cases, all attributes of a specific light can be found in a light manual accompanying the light.

In an implementation process of the aspects of this disclosure, the applicant finds that the following problems exist in the related art.

In the related art, because virtual projection is used when graphic is projected, during projection of some objects or components by some versions of software, a problem that the graphic is incorrect or even a projection is missing may occur. Consequently, there is a large limitation to a version requirement of a running environment in the related art. According to the aspects of this disclosure, a graphic projection manner may be implemented based on a method of physical illumination of light in the unreal engine, and is applicable to running environments of all versions, thereby effectively improving universality of a running environment for processing a virtual ray.

The aspects of this disclosure provide a virtual ray processing method and apparatus, an electronic device, a computer-readable storage medium, and a computer program product, to more effectively improve universality of a running environment for processing a virtual ray. The following describes an application of a virtual ray processing system provided in the aspects of this disclosure.

FIG. 1 is a schematic architectural diagram of a virtual ray processing system 100 according to an aspect of this disclosure. A terminal (where a terminal 400 is shown) is connected to a server 200 by a network 300. The network 300 may be a wide area network, a local area network, or a combination of thereof.

The terminal 400 is configured for a user to use a client 410, and displays a virtual scene on a graphic interface 410-1 (where the graphical interface 410-1 is shown). The terminal 400 and the server 200 are connected to each other by a wired or wireless network.

In some aspects, the server 200 may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The terminal 400 may be a smartphone, a tablet computer, a laptop, a desktop computer, a smart speaker, a smart television, a smartwatch, an in-vehicle terminal, or the like, but is not limited thereto. The electronic device provided in the aspects of this disclosure may be implemented as a terminal, or may be implemented as a server. The terminal and the server may be connected directly or indirectly in a wired or wireless communication manner, which is not limited in the aspects of this disclosure.

In some aspects, the virtual ray processing method provided in the aspects of this disclosure is applicable to application scenarios such as the virtual production and game production.

For example, in the application scenario of the virtual production, a light special effect is usually needed, to form graphic satisfying a corresponding arrangement rule in a produced video. Because producing a corresponding light special effect in the real world usually needs to reconfigure or upgrade a light source in the real world, production costs are large. According to the virtual ray processing method provided in the aspects of this disclosure, the corresponding light special effect can be produced in various versions of production engines, thereby effectively improving universality of a running environment for processing a virtual ray and effectively reducing production costs. When the terminal 400 is used to perform virtual production, in response to an operation performed by a producer on the graphic interface 400-1, the terminal 400 determines a light source position of a virtual light source configured to form a virtual ray in the produced video, and arranges the virtual light source with a corresponding light source parameter at the light source position. In response to a light special effect triggering operation performed by the producer on the virtual light source, the terminal 400 determines a target size of a virtual obstruction based on the light source parameter and a target position, generates a virtual obstruction with the target size at the target position in the produced video, and controls the virtual light source to illuminate the virtual obstruction, so that the virtual ray emitted by the virtual light source passes through a transparent channel, to form graphic satisfying an arrangement rule (that is, the light special effect) in the produced video.

For another example, in the application scenario of the game production, a light special effect is usually needed, to form graphic satisfying a corresponding arrangement rule in a produced virtual game scene, so that the produced game is more vivid. In the virtual ray processing method provided in the aspects of this disclosure, when the terminal 400 is used to produce a game, in response to an operation performed by a producer on the graphic interface 400-1, the terminal 400 determines a light source position of a virtual light source configured to form a virtual ray in the virtual game scene, and arranges the virtual light source with a corresponding light source parameter at the light source position. In response to a light special effect triggering operation performed by the producer on the virtual light source, the terminal 400 determines a target size of a virtual obstruction based on the light source parameter and a target position, generates a virtual obstruction with the target size at the target position in the virtual game scene, and controls the virtual light source to illuminate the virtual obstruction, so that the virtual ray emitted by the virtual light source passes through a transparent channel, to form graphics satisfying an arrangement rule in the virtual game scene.

In some aspects, the terminal 400 obtains a light source position and a light source parameter of a virtual light source, determines a target position in a virtual scene based on the light source position, determines a target size of a virtual obstruction based on the target position and the light source parameter, generates the virtual obstruction with the target size at the target position in the virtual scene, and controls the virtual light source to illuminate the virtual obstruction, so that a virtual ray emitted by the virtual light source passes through a transparent channel, to form graphics satisfying an arrangement rule in the virtual scene.

In some other aspects, the server 200 obtains a light source position and a light source parameter of a virtual light source, determines a target position in a virtual scene based on the light source position, determines a target size of a virtual obstruction based on the target position and the light source parameter, and sends the target position and the target size to the terminal 400. The terminal 400 generates the virtual obstruction with the target size at the target position in the virtual scene, and controls the virtual light source to illuminate the virtual obstruction, so that a virtual ray emitted by the virtual light source passes through a transparent channel, to form graphics satisfying an arrangement rule in the virtual scene.

In some other aspects, the aspects of this disclosure may be implemented by using a cloud technology. The cloud technology refers to a hosting technology that unifies a series of resources such as hardware, software, and networks within a wide area network or a local area network to implement computing, storage, processing, and sharing of data.

The cloud technology is a generic term of a network technology, an information technology, an integration technology, a management platform technology, and an application technology based on application of a cloud computing business mode, and may form a resource pool and is used on demand, which is flexible and convenient. The cloud computing technology will become an important support. Backend services of a technology network system require a lot of computing and storage resources.

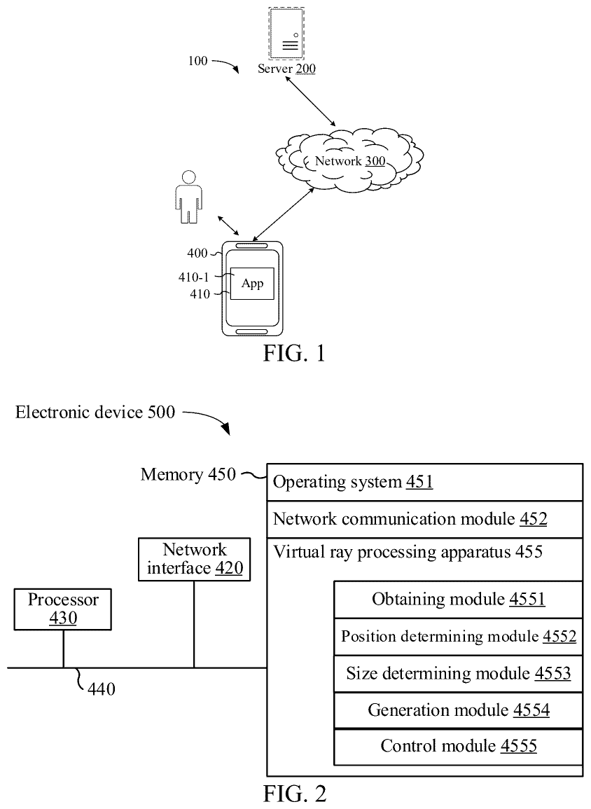

FIG. 2 is a schematic structural diagram of an electronic device 500 configured to process a virtual ray according to an aspect of this disclosure. The electronic device 500 shown in FIG. 2 may be the server 200 or the terminal 400 in FIG. 1. The electronic device 500 shown in FIG. 2 includes: processing circuitry, such as at least one processor 430, a memory 450 (e.g., a non-transitory computer-readable storage medium), and at least one network interface 420. Components in the electronic device 500 are coupled together through a bus system 440. The bus system 440 is configured to achieve connected communication between the components. In addition to a data bus, the bus system 440 further includes a power supply bus, a control bus, and a status signal bus. However, for clarity, various buses are marked as the bus system 440 in FIG. 2.

The processor 430 may be an integrated circuit chip having a signal processing capability, for example, a general purpose processor, a digital signal processor (DSP), another programmable logic device, discrete gate or transistor logic device, or discrete hardware component, or the like. The general purpose processor may be a microprocessor or any conventional processor, or the like.

The memory 450 may be removable, irremovable or a combination thereof. For example, a hardware device includes a solid memory, a hard disk drive, an optical disk drive, and the like. The memory 450 includes one or more storage devices located physically away from the processor 430.

The memory 450 may include a volatile memory or a non-volatile memory, or may include both the volatile memory and the non-volatile memory. The non-volatile memory may be a read-only memory (ROM), and the volatile memory may be a random-access memory (RAM). The memory 450 described in this aspect of this disclosure aims to include any suitable type of memory.

In some aspects, the memory 450 can store data to support various operations. Examples of the data include a program, a module, a data structure, or a subset or a superset thereof, which are described below by way of example.

An operating system 451 includes system programs configured to process various basic system services and perform hardware-related tasks, for example, a framework layer, a core library layer, and a driver layer, which are configured to implement various basic services and process hardware-based tasks.

A network communication module 452 is configured to reach another electronic device via one or more (wired or wireless) network interfaces 420. For example, the network interface 420 includes: a Bluetooth interface, a wireless interface such as Wi-Fi, a universal serial bus (USB) interface, and the like.

In some aspects, the virtual ray processing apparatus provided in the aspects of this disclosure may be implemented by software. FIG. 2 shows a virtual ray processing apparatus 455 stored in the memory 450, which may be software in a form of a program and a plug-in, and includes the following software modules: an obtaining module 4551, a position determining module 4552. a size determining module 4553, a generation module 4554, and a control module 4555. These modules are logical modules, and therefore may be combined in different manners to form other aspects or further split according to the implemented functions. The functions of the modules are described below.

In some other aspects, the virtual ray processing apparatus provided in the aspects of this disclosure may be implemented by using hardware. In an example, the virtual ray processing apparatus provided in the aspects of this disclosure may be a processor in a form of a hardware decoding processor, programmed to perform the virtual ray processing method provided in the aspects of this disclosure. For example, the processor in the form of the hardware decoding processor may use one or more application specific integrated circuits (ASIC), a DSP, a programmable logic device (PLD), a complex programmable logic device (CPLD), a field-programmable gate array (FPGA), or other electronic components.

In some aspects, the terminal or the server may implement the virtual ray processing method provided in the aspects of this disclosure by executing a computer program or computer-executable instructions. For example, the computer program may be a native program (for example, a dedicated virtual ray processing program) in an operating system or a software module, for example, a virtual ray processing module that may be embedded in any program (such as an instant messaging client, an album program, an electronic map client, or a navigation client); or may be a native application (APP), that is, a program that needs to be installed in the operating system for running. In summary, the computer program may be an application, a module, or a plug-in in any form.

The virtual ray processing method provided in the aspects of this disclosure is described in combination with the applications and implementations of the server or the terminal provided in the aspects of this disclosure.

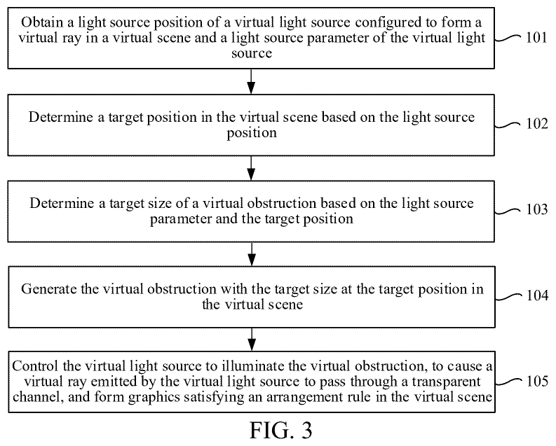

FIG. 3 is a schematic flowchart 1 of a virtual ray processing method according to an aspect of this disclosure. Descriptions are provided with reference to operation 101 to operation 105 shown in FIG. 3. The virtual ray processing method provided in this aspect of this disclosure may be independently implemented by a server or a terminal, or may be cooperatively implemented by a server and a terminal. The following describes an example in which the server independently implements the method.

Operation 101: Obtain a light source position of a virtual light source configured to form a virtual ray in a virtual scene and a light source parameter of the virtual light source. For example, a light source position of a virtual light source in a virtual scene and at least one light source parameter of the virtual light source is obtained. The virtual light source emits a plurality of virtual rays in the virtual scene.

In some aspects, the light source position is configured for indicating three-dimensional position coordinates of the virtual light source in the virtual scene in a coordinate system of the virtual scene, namely, a three-dimensional coordinate position of a geometric center of the virtual light source in the virtual scene in the coordinate system of the virtual scene. The virtual light source is configured to form the virtual ray in the virtual scene.

In some aspects, the virtual light source is a “light source” set up in the computer animation software or the virtual engine. A function of the virtual light source for expressing viewpoints during animation production is equivalent to a conventional physical light source. Objects illuminated by the virtual light source are totally different from objects illuminated by the physical light source, but functions are extremely similar. The physical light source illuminates real people or an actually built scene, and the virtual light source illuminates a model built in the three-dimensional software, which can implement unlimited possibilities.

In some aspects, the virtual ray is a ray in a virtual scene emitted by the virtual light source configured to illuminate the virtual scene. The virtual ray includes a direct ray and an indirect ray. The direct ray is a virtual ray emitted by the virtual light source and reflected to the virtual camera by a virtual illumination point. The indirect ray is a virtual ray emitted by the virtual light source to a virtual illumination point after being reflected at least once, and finally reflected to the virtual camera by the virtual illumination point.

In some aspects, the light source parameter includes an illumination open angle of the virtual light source, and the illumination open angle is configured for indicating an angle between a boundary virtual ray and a central virtual ray that are emitted by the virtual light source.

Operation 102: Determine a target position in the virtual scene based on the light source position. For example, a target position in the virtual scene that is illuminated by the virtual light source is determined based on the light source position.

In some aspects, a connection line between the target position and the virtual light source coincides with the central virtual ray, the central virtual ray is a central virtual ray in a plurality of virtual rays emitted by the virtual light source, and the target position is a position located on the central virtual ray.

In some aspects, the connection line between the target position and the virtual light source is a connection line between the target position and a central position of the virtual light source.

In some aspects, the central virtual ray is the central virtual ray in the plurality of virtual rays emitted by the virtual light source. The plurality of virtual rays emitted by the virtual light source include two edge virtual rays and one central virtual ray. The edge virtual ray is a virtual ray with another virtual ray on one side and without a virtual ray on the other side, and distances between the central virtual ray and the two edge virtual rays are equal.

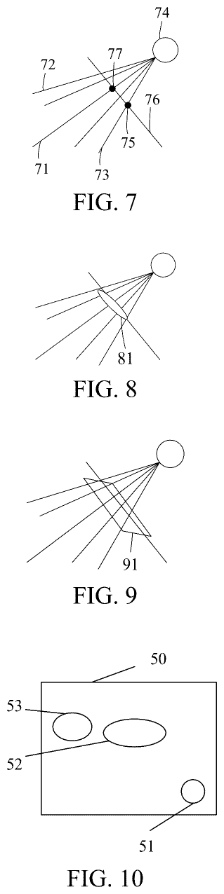

In an example, FIG. 7 is a schematic principle diagram 1 of a virtual ray processing method according to an aspect of this disclosure, a plurality of virtual rays emitted by a virtual light source 74 include a central virtual ray 71, an edge virtual ray 72, and an edge virtual ray 73.

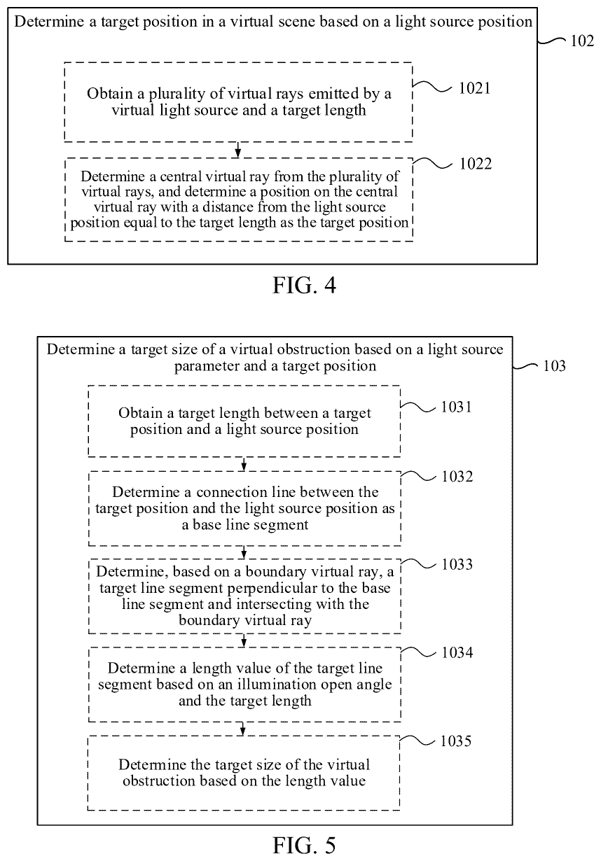

In some aspects, FIG. 4 is a schematic flowchart 2 of a virtual ray processing method according to an aspect of this disclosure, and operation 102 shown in FIG. 3 may be implemented by performing operation 1021 and operation 1022 shown in FIG. 4.

Operation 1021: Obtain a plurality of virtual rays emitted by the virtual light source and a target length. For example, a light source position of a virtual light source in a virtual scene and at least one light source parameter of the virtual light source is obtained. The virtual light source emits a plurality of virtual rays in the virtual scene.

In some aspects, the target length is less than a length of the central virtual ray.

In some aspects, the length of the central virtual ray is a length of the central virtual ray in the virtual scene. A start point of the central virtual ray is the virtual light source emitting the central virtual ray, an end point of the central virtual ray is a scene position to which the central virtual ray is emitted in the virtual scene, the central virtual ray is a straight line in the virtual scene, and the central virtual ray does not include a reflected ray of the central virtual ray at the scene position.

In an example, referring to FIG. 7, the plurality of virtual rays, for example, five virtual rays (including the edge virtual ray 72, the edge virtual ray 73, and the central virtual ray 71) shown in FIG. 7, emitted by the virtual light source 74 are obtained.

Operation 1022: Determine the central virtual ray from the plurality of virtual rays, and determine a position on the central virtual ray with a distance from the light source position equal to the target length as the target position. For example, from the plurality of virtual rays, a central virtual ray of an illumination axis of the virtual light source is identified. Along the central virtual ray, the target position located at a target length from the light source position is selected. The target length is calculated based on the at least one light source parameter.

In some aspects, the determining the central virtual ray from the plurality of virtual rays may be implemented in the following manner: performing the following processing on each virtual ray: determining the virtual ray as a candidate virtual ray when there are two other virtual rays adjacent to the virtual ray; and determining the candidate virtual ray as the central virtual ray when quantities of other virtual rays on two sides of the candidate virtual ray are equal.

In an example, referring to FIG. 7, for the virtual ray 71, there are two other virtual rays adjacent to the virtual ray 71, the virtual ray 71 is determined as the candidate virtual ray, and there are two other virtual rays on both sides of the candidate virtual ray 71. That is, there are equal quantities of other virtual rays on both sides of the candidate virtual ray 71, and the candidate virtual ray 71 is determined as a central virtual ray.

In an example, referring to FIG. 7, the central virtual ray 71 is determined from the plurality of virtual rays, and a position on the central virtual ray 71 with a distance from the light source position 74 equal to a target length is determined as a target position 77.

In this way, the target position in the virtual scene is determined based on the light source position, facilitating subsequently setting a virtual obstruction at the target position, so that the virtual obstruction blocks the virtual ray emitted by the virtual light source. The manner of setting a physical obstruction in the virtual scene is applicable to various application scenarios, and can effectively improve scene universality of processing a virtual ray.

Operation 103: Determine a target size of the virtual obstruction based on the light source parameter and the target position. For example, a target size of a virtual mask is determined based on the at least one light source parameter and the target position. The virtual mask is configured to block at least a portion of the plurality of virtual rays to generate a light pattern.

In some aspects, the virtual obstruction is configured to block the virtual ray emitted by the virtual light source, and the virtual ray emitted by the virtual light source cannot pass through a blocking surface of the virtual obstruction.

In some aspects, the light source parameter includes an illumination open angle of the virtual light source, and the illumination open angle is configured for indicating an angle between the boundary virtual ray and the central virtual ray that are emitted by the virtual light source.

In some aspects, the boundary virtual ray is a virtual ray located at an edge of the plurality of virtual rays emitted by the virtual light source, and the boundary virtual ray is a virtual ray with only one adjacent virtual ray in the plurality of virtual rays emitted by the virtual light source.

In some aspects, the boundary virtual ray may be determined in the following manner: for each of the plurality of virtual rays, obtaining a quantity of other virtual rays adjacent to the virtual ray, and determining the virtual ray as the boundary virtual ray when the quantity is 1.

In an example, referring to FIG. 7, the boundary virtual ray may be the virtual ray 72 and the virtual ray 73 in the plurality of virtual rays emitted by the virtual light source 74.

In an example, referring to FIG. 7, the illumination open angle of the virtual light source is configured for indicating an angle between the boundary virtual ray 73 and the central virtual ray 71 that are emitted by the virtual light source.

In some aspects, FIG. 5 is a schematic flowchart 3 of a virtual ray processing method according to an aspect of this disclosure, and operation 103 shown in FIG. 3 may be implemented by performing operation 1031 to operation 1035 shown in FIG. 5.

Operation 1031: Obtain a target length between the target position and the light source position. For example, along the central virtual ray, the target position located at a target length from the light source position is selected. The target length being calculated based on the at least one light source parameter.

In some aspects, the target length is configured for indicating a distance length between the target position and the light source position.

Operation 1032: Determine a connection line between the target position and the light source position as a base line segment. For example, a base line segment connecting the target position and the light source position is determined.

In an example, referring to FIG. 7, a connection line between the target position 77 and the light source position 74 is determined as a base line segment, and the distance length is a line segment length of the base line segment.

Operation 1033: Determine, based on the boundary virtual ray, a target line segment perpendicular to the base line segment and intersecting with the boundary virtual ray. For example, based on the boundary virtual ray, a target line segment perpendicular to the base line segment and intersecting the boundary virtual ray is determined.

In some aspects, line segment endpoints of the target line segment are respectively located on the boundary virtual ray and the base line segment, and the target line segment and the boundary virtual ray are in a one-to-one correspondence, that is, one boundary virtual ray corresponds to one target line segment. Operation 1033 may be implemented in the following manner: obtaining a target line perpendicular to the base line segment, and determining an intersection point between the boundary virtual ray and the target line; and determining a line segment from the intersection point on the target line to the target position as the target line segment.

In an example, referring to FIG. 7, a target line 76 perpendicular to the base line segment (namely, the connection line between the target position 77 and the light source position 74) is obtained, an intersection point 75 between the boundary virtual ray and the target line is determined, and a line segment from the intersection point 75 on the target line 76 to the target position 77 is determined as the target line segment.

Operation 1034: Determine a length value of the target line segment based on the illumination open angle and the target length. For example, a length value of the target line segment is determined based on the illumination open angle and the target length.

In an example, referring to FIG. 7, based on the illumination open angle (namely, the angle between the boundary virtual ray 73 and the central virtual ray 71) and the target length (namely, the distance length between the target position 77 and the light source position 74), a length value of the target line segment (namely, the line segment between the intersection point 75 on the target line 76 and the target position 77) is determined.

In some aspects, operation 1034 may be implemented in the following manner: obtaining an included angle between the boundary virtual ray and the target line segment, and determining a cosine value of the included angle; obtaining a cosine value of the illumination open angle, and determining a ratio of the cosine value of the illumination open angle to the cosine value of the included angle; and determining an integer multiple of a product of the target length and the ratio as the length value of the target line segment.

In an example, referring to FIG. 7, an included angle between the boundary virtual ray 73 and the target line segment 76 is obtained, and a cosine value of the included angle is determined; a cosine value of the illumination open angle (namely, the angle between the boundary virtual ray 73 and the central virtual ray 71) is obtained, and a ratio of the cosine value of the illumination open angle (namely, the angle between the boundary virtual ray 73 and the central virtual ray 71) to the cosine value of the included angle is determined; and an integer multiple of a product of the target length (namely, the distance length between the target position 77 and the light source position 74) and the ratio is determined as the length value of the target line segment.

In an example, an expression of the length value of the target line segment may be:

$$b = kc \frac{sin B}{sin C} \qquad ( 1 )$$

b is configured for indicating a length value of a target line segment, C is configured for indicating a target length, sinB is configured for indicating a cosine value of an illumination open angle, sinC is configured for indicating a cosine value of an included angle, and k is configured for indicating a positive integer.

Operation 1035: Determine the target size of the virtual obstruction based on the length value. For example, the target size of the virtual mask is determined based on the length value.

In some aspects, the target size includes a two-dimensional target size or a three-dimensional target size. The target size of the virtual obstruction is configured for indicating a size of an area or a volume occupied by the virtual obstruction in the virtual scene. The two-dimensional target size is configured for indicating the size of the area occupied by the virtual obstruction in the virtual scene. The three-dimensional target size is configured for indicating the size of the volume occupied by the virtual obstruction in the virtual scene.

In some aspects, operation 1035 may be implemented in the following manner: determining a dimension of the virtual obstruction in response to a dimension selection operation for the virtual obstruction; and determining the two-dimensional target size of the virtual obstruction based on the length value when the dimension of the virtual obstruction is two-dimensional; or determining the three-dimensional target size of the virtual obstruction based on the length value when the dimension of the virtual obstruction is three-dimensional.

In some aspects, when a selected dimension of the virtual obstruction is two-dimensional, the corresponding virtual obstruction is a two-dimensional virtual obstruction. Because memory space occupation of the two-dimensional virtual obstruction in the virtual scene is less than memory space occupation of a three-dimensional virtual obstruction (in a case that an area of a bottom surface of the three-dimensional virtual obstruction is equal to an area of the two-dimensional virtual obstruction), selecting the two-dimensional virtual obstruction to block the virtual ray emitted by the virtual light source can significantly reduce memory space occupation of the virtual scene, and effectively improve processing efficiency of the virtual ray.

In some aspects, when a selected dimension of the virtual obstruction is three-dimensional, the corresponding virtual obstruction is a three-dimensional virtual obstruction. Because memory space occupation of the three-dimensional virtual obstruction in the virtual scene is larger, but compared with the two-dimensional virtual obstruction, a plurality of side surfaces are added to the three-dimensional virtual obstruction, so that the virtual ray emitted by the virtual light source can be more effectively blocked, and another virtual ray caused by diffuse reflection of the virtual ray can be effectively blocked, thereby effectively improving a ray blocking effect of the virtual obstruction.

In some aspects, the determining the two-dimensional target size of the virtual obstruction based on the length value may be implemented in the following manner: determining a shape of the virtual obstruction in response to a shape selection operation for the virtual obstruction; and when the shape of the virtual obstruction is a circle and the two-dimensional target size includes a radius of the circle, determining the length value as the radius of the circle; or when the shape of the virtual obstruction is a rectangle and the two-dimensional target size includes a side length of the rectangle, determining an integer multiple of the length value as the side length of the rectangle.

In an example, FIG. 8 is a schematic principle diagram 1 of a two-dimensional virtual obstruction according to an aspect of this disclosure. When a shape of a virtual obstruction 81 is a circle and a two-dimensional target size includes a radius of the circle, a length value is determined as the radius of the circle.

In an example, FIG. 9 is a schematic principle diagram 2 of a two-dimensional virtual obstruction according to an aspect of this disclosure. When a shape of a virtual obstruction 91 is a rectangle and a two-dimensional target size includes a side length of the rectangle, an integer multiple of a length value is determined as the side length of the rectangle.

In some aspects, when the shape of the virtual obstruction is the rectangle, the two-dimensional target size includes the side length of the rectangle, the side length of the rectangle includes a length of the rectangle and a width of the rectangle. The length of the rectangle and the width of the rectangle may be equal or not equal. When the length of the rectangle is equal to the width of the rectangle, a third integer multiple of the length value may be determined as the length of the rectangle, a fourth integer multiple of the length value may be determined as the width of the rectangle, and the third integer multiple is equal to the fourth integer multiple. When the length of the rectangle is not equal to the width of the rectangle, a fifth integer multiple of the length value may be determined as the length of the rectangle, a sixth integer multiple of the length value may be determined as the width of the rectangle, and the fifth integer multiple is not equal to the sixth integer multiple.

In some aspects, when the virtual obstruction is a cuboid, the three-dimensional target size includes a length, a height, and a width of the cuboid.

In some aspects, the determining the three-dimensional target size of the virtual obstruction based on the length value may be implemented in the following manner: determining a first integer multiple of the length value of the target line segment as the length of the cuboid, and determining a second integer multiple of the length value of the target line segment as the width of the cuboid; obtaining an illumination intensity of the virtual light source, dividing the illumination intensity by a reference illumination intensity, and determining a division result as a target multiple of the length value of the target line segment; and determining the length value of the target multiple as the height of the cuboid.

In some aspects, a larger illumination intensity of the virtual light source indicates a larger value of a corresponding target multiple, a smaller illumination intensity of the virtual light source indicates a smaller value of a corresponding target multiple, and the illumination intensity of the virtual light source is positively correlated with the value of the corresponding target multiple.

In an example, an expression of the target multiple of the length of the target line segment may be:

$$B = \frac{G}{{G}_{1}} \qquad ( 2 )$$

B is configured for indicating a target multiple of a length of a target line segment, G is configured for indicating an illumination intensity of a virtual light source, and G₁ is configured for indicating a reference illumination intensity.

In this way, the virtual obstruction is set to the three-dimensional virtual obstruction, and the height of the three-dimensional virtual obstruction is set to a height positively correlated with the illumination intensity of the virtual light source, so that the three-dimensional virtual obstruction of an appropriate height can block a reflected virtual ray generated through diffuse reflection of the virtual ray of the virtual light source, to effectively improve a blocking effect of the virtual obstruction.

Operation 104: Generate the virtual obstruction with the target size at the target position in the virtual scene. For example, the virtual mask with the target size is generated at the target position in the virtual scene. The virtual mask includes at least one transparent channel arranged according to an arrangement rule.

In some aspects, at least one transparent channel arranged according to an arrangement rule is set on the virtual obstruction.

In some aspects, the arrangement rule refers to a position at which the transparent channel is placed on the virtual obstruction. A position relationship of different transparent channels on the virtual obstruction can be indicated through the arrangement rule.

For example, FIG. 10 is a schematic principle diagram 2 of a virtual ray processing method according to an aspect of this disclosure. FIG. 10 shows a surface 50 of a virtual obstruction. A transparent channel 51, a transparent channel 52, and a transparent channel 53 that are arranged according to an arrangement rule are set on the virtual obstruction 50. The arrangement rule may be that the transparent channel 51 is below the transparent channel 52 and the transparent channel 53, the transparent channel 53 is on the left of the transparent channel 52 and the transparent channel 51, or the like.

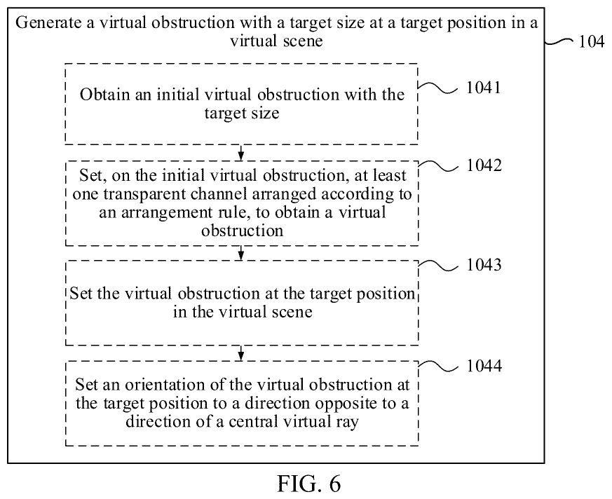

In some aspects, FIG. 6 is a schematic flowchart 4 of a virtual ray processing method according to an aspect of this disclosure, and operation 104 shown in FIG. 3 may be implemented by performing operation 1041 to operation 1044 shown in FIG. 6.

Operation 1041: Obtain an initial virtual obstruction with the target size. For example, an initial virtual mask with the target size is obtained.

In some aspects, a size type of the target size includes a two-dimensional target size and a three-dimensional target size. When the size type of the target size is the two-dimensional target size, the initial virtual obstruction is a two-dimensional virtual obstruction, and when the size type of the target size is the three-dimensional target size, the initial virtual obstruction is a three-dimensional virtual obstruction.

In some aspects, the initial virtual obstruction is configured to block the virtual ray, and the virtual ray cannot pass through surfaces of the virtual obstruction.

In some aspects, operation 1041 may be implemented in the following manner: obtaining the size type of the target size; and creating a two-dimensional virtual obstruction with the two-dimensional target size when the size type is the two-dimensional target size, the virtual ray emitted by the virtual light source being incapable of passing through the two-dimensional virtual obstruction; and determining the two-dimensional virtual obstruction as the initial virtual obstruction; or creating a three-dimensional virtual obstruction with the three-dimensional target size when the size type is the three-dimensional target size, the three-dimensional virtual obstruction being a polyhedron having a plurality of surfaces, and the virtual ray emitted by the virtual light source being incapable of passing through the surfaces of the polyhedron; and setting any one of the surfaces of the three-dimensional virtual obstruction as a transparent surface, to obtain the initial virtual obstruction, the virtual ray emitted by the virtual light source being capable of passing through the transparent surface.

In an example, when the size type is the two-dimensional target size, the two-dimensional virtual obstruction with the two-dimensional target size (for example, a length of 10 and a width of 20) is created, and the virtual ray emitted by the virtual light source cannot pass through the two-dimensional virtual obstruction.

In some aspects, a geometry formed by several planar polygons is referred to as a polyhedron. The polygon that forms the polyhedron is referred to as a face of the polyhedron. A common edge of two faces is referred to as an edge of the polyhedron. A common vertex of several edges is referred to as a vertex of the polyhedron, and any face of the polyhedron is extended, if other faces are on a same side of the plane, the polyhedron is referred to as a convex polyhedron. The polyhedron has at least four faces, and the polyhedron is respectively referred to as a tetrahedron, a pentahedron, a hexahedron, and the like according to a quantity of faces.

In some aspects, the creating a three-dimensional virtual obstruction with the three-dimensional target size may be implemented in the following manner: in response to a selection operation for the polyhedron, determining a target quantity of faces in the polyhedron, and creating a polyhedron with a target quantity of faces and the three-dimensional target size.

In an example, a three-dimensional virtual obstruction with the three-dimensional target size is created when the size type is the three-dimensional target size, the three-dimensional virtual obstruction is a polyhedron having a plurality of surfaces, and the virtual ray emitted by the virtual light source cannot pass through the surfaces of the polyhedron; and any one of the surfaces of the three-dimensional virtual obstruction is set as a transparent surface, to obtain the initial virtual obstruction, the virtual ray emitted by the virtual light source can pass through the transparent surface, and the virtual ray emitted by the virtual light source cannot pass through other surfaces than the transparent surface.

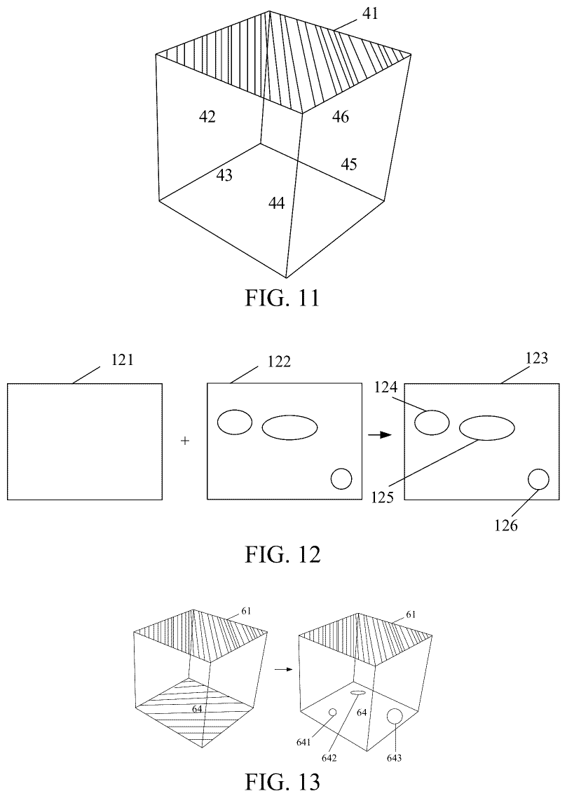

In an example, FIG. 11 is a schematic effect diagram of a three-dimensional virtual obstruction according to an aspect of this disclosure. When the size type is the three-dimensional target size, the three-dimensional virtual obstruction (for example, a hexahedron shown in FIG. 11) with the three-dimensional target size is created. The three-dimensional virtual obstruction is a hexahedron having six surfaces, and the virtual ray emitted by the virtual light source cannot pass through a surface of the hexahedron. Any surface of the three-dimensional virtual obstruction is set to a transparent surface (for example, a surface 41 is set to the transparent surface), to obtain an initial virtual obstruction. Referring to the initial virtual obstruction shown in FIG. 11, the surface 41 is the transparent surface, a surface 42, a surface 43, a surface 44, a surface 45, and a surface 46 are non-transparent surfaces. The virtual ray emitted by the virtual light source can pass through the transparent surface 41, and the virtual ray emitted by the virtual light source cannot pass through other surfaces (the surface 42, the surface 43, the surface 44, the surface 45, and the surface 46) than the transparent surface.

In this way, any surface of the three-dimensional virtual obstruction is set to the transparent surface, to obtain the initial virtual obstruction, so that the virtual ray can enter inner space of the three-dimensional virtual obstruction through the transparent surface. Because the virtual ray emitted by the virtual light source cannot pass through other surfaces than the transparent surface, the virtual ray emitted by the virtual light source can be more effectively blocked, and another virtual ray caused by diffuse reflection of the virtual ray can be effectively blocked, thereby effectively improving the ray blocking effect of the virtual obstruction.

Operation 1042: Set, on the initial virtual obstruction, at least one transparent channel arranged according to the arrangement rule, to obtain the virtual obstruction. For example, on the initial virtual mask, the at least one transparent channel arranged according to the arrangement rule is formed to obtain the virtual mask.

In an example, referring to FIG. 10, the transparent channel 51, the transparent channel 52, and the transparent channel 53 that are arranged according to the arrangement rule are set on the initial virtual obstruction 50, to obtain the virtual obstruction.

In some aspects, operation 1042 may be implemented in the following manner: obtaining a transparent channel map, the transparent channel map being configured for indicating the arrangement rule of the transparent channel and a channel shape of each transparent channel, and a map size of the transparent channel map matching the target size of the virtual obstruction; and setting the transparent channel on the initial virtual obstruction according to the arrangement rule indicated by the transparent channel map, to obtain the virtual obstruction.

In some aspects, after operation 1042, the virtual obstruction may further updated in the following manner: obtaining an updated transparent channel map in response to a pattern update operation for the virtual obstruction, an updated arrangement rule indicated by the updated transparent channel map being different from the arrangement rule indicated by the transparent channel map, and updating the virtual obstruction according to the arrangement rule indicated by the updated transparent channel, to obtain an updated virtual obstruction.

In some aspects, that the map size of the transparent channel map matches the target size of the virtual obstruction means that the map size of the transparent channel map is less than or equal to the target size of the virtual obstruction, thereby ensuring that the map size of the transparent channel map can be adhered to the initial virtual obstruction.

In an example, referring to FIG. 10, the arrangement rule of the transparent channel may be a relative position relationship between different transparent channels such as the transparent channel 51 being below the transparent channel 52 and the transparent channel 53, the transparent channel 52 being on the left of the transparent channel 53, and the transparent channel 52 being on the right of the transparent channel 51. A channel shape of the transparent channel 51 is circular, a channel shape of the transparent channel 52 is oval, and a channel shape of the transparent channel 53 may be oval.

In some aspects, when the initial virtual obstruction is the two-dimensional virtual obstruction, the setting the transparent channel on the initial virtual obstruction according to the arrangement rule indicated by the transparent channel map, to obtain the virtual obstruction may be implemented in the following manner: arranging the transparent channel map on a surface of the two-dimensional virtual obstruction; determining an area on the surface of the two-dimensional virtual obstruction coinciding with the transparent channel of each channel shape in the transparent channel map as a target area; and setting each target area on the two-dimensional virtual obstruction to a transparent area, to obtain the virtual obstruction, the virtual ray emitted by the virtual light source being capable of passing through the transparent area.

In an example, FIG. 12 is a schematic principle diagram 1 of a two-dimensional virtual obstruction according to an aspect of this disclosure. A transparent channel map 121 is arranged on a surface of a two-dimensional virtual obstruction 122. Areas (an area 124, an area 125, and an area 126) on the surface of the two-dimensional virtual obstruction coinciding with a transparent channel of each channel shape in the transparent channel map 122 are determined as target areas. The target areas (the area 124, the area 125, and the area 126) on the two-dimensional virtual obstruction are set to transparent areas, to obtain the virtual obstruction 123, and the virtual ray emitted by the virtual light source can pass through the transparent areas (the area 124, the area 125, and the area 126).

In some other aspects, when the initial virtual obstruction is the three-dimensional virtual obstruction, the three-dimensional virtual obstruction is a polyhedron, and the polyhedron includes a transparent surface, the setting the transparent channel on the initial virtual obstruction according to the arrangement rule indicated by the transparent channel map, to obtain the virtual obstruction may be implemented in the following manner: determining a blocking surface on the three-dimensional virtual obstruction farthest from the transparent surface as a target blocking surface; arranging the transparent channel map on the target blocking surface; determining an area on the target blocking surface coinciding with the transparent channel of each channel shape in the transparent channel map as a target area; and setting each target area on the target blocking surface on the three-dimensional virtual obstruction to a transparent area, to obtain the virtual obstruction, the virtual ray emitted by the virtual light source being capable of passing through the transparent area.

In an example, FIG. 13 is a schematic principle diagram of a three-dimensional virtual obstruction according to an aspect of this disclosure. A blocking surface 64 farthest from a transparent surface 61 in a three-dimensional virtual obstruction is determined as a target blocking surface. The transparent channel map is arranged on the target blocking surface 64. An area on the target blocking surface 64 coinciding with the transparent channel of each channel shape in the transparent channel map is determined as a target area. Target areas (a target area 641, a target area 642, and a target area 643) on the target blocking surface on the three-dimensional virtual obstruction are set to transparent areas, to obtain the virtual obstruction, and the virtual ray emitted by the virtual light source can pass through the transparent areas.

In this way, when the initial virtual obstruction is the three-dimensional virtual obstruction, and the three-dimensional virtual obstruction is a polyhedron, the blocking surface on the three-dimensional virtual obstruction farthest from the transparent surface is determined as the target blocking surface. The transparent channel map is arranged on the target blocking surface. The area on the target blocking surface coinciding with the transparent channel of each channel shape in the transparent channel map is determined as the target area. Each target area on the target blocking surface on the three-dimensional virtual obstruction is set to the transparent area, to obtain the virtual obstruction, so that the virtual ray emitted by the virtual light source can pass through the transparent area. In this way, after passing through the transparent surface, the virtual ray can pass through the transparent area of the blocking surface farthest from the transparent surface, so that graphics satisfying the arrangement rule is formed in the virtual scene, thereby effectively improving the ray display effect of the virtual ray.

Operation 1043: Setting the virtual obstruction at the target position in the virtual scene. For example, a geometric center point of the virtual mask is set at the target position.

In some aspects, a geometric center point of the virtual obstruction coincides with the target position.

In some aspects, operation 1043 may be implemented in the following manner: setting the center point of the virtual obstruction at a position coinciding with the target position.

Operation 1044: Set an orientation of the virtual obstruction at the target position to a direction opposite to a direction of the central virtual ray. For example, an orientation of the virtual mask is set at the target position opposite to a direction of the central virtual ray.

In some aspects, a direction of the central virtual ray is a direction from the virtual light source to the corresponding virtual obstruction, so that the orientation of the virtual obstruction at the target position is a direction from the virtual obstruction to the virtual light source. When the virtual obstruction is the two-dimensional virtual obstruction, an orientation of the two-dimensional virtual obstruction at the target position coincides with a normal direction of a plane on which the two-dimensional virtual obstruction is located. When the virtual obstruction is the three-dimensional virtual obstruction, an orientation of the three-dimensional virtual obstruction at the target position coincides with a normal direction of a plane on which the target surface of the three-dimensional virtual obstruction is located.

In an example, referring to FIG. 9, when the virtual obstruction is the two-dimensional virtual obstruction 91, an orientation of the two-dimensional virtual obstruction 91 at the target position coincides with a normal direction of a plane on which the two-dimensional virtual obstruction 91 is located, and is opposite to a direction of a central virtual ray.

In an example, referring to FIG. 13, when the virtual obstruction is the three-dimensional virtual obstruction, an orientation of the three-dimensional virtual obstruction at the target position coincides with a normal direction of a plane on which the target surface 64 of the three-dimensional virtual obstruction is located.

Operation 105: Control the virtual light source to illuminate the virtual obstruction, to cause a virtual ray emitted by the virtual light source to pass through the transparent channel, and form graphics satisfying the arrangement rule in the virtual scene. For example, the virtual light source is controlled to illuminate the virtual mask. A subset of the plurality of virtual rays passes through the at least one transparent channel to form the light pattern corresponding to the arrangement rule of the at least one transparent channel in the virtual mask.

In some aspects, the virtual light source is controlled to illuminate the virtual obstruction at the target position, so that the virtual ray emitted by the virtual light source can pass through the transparent channel on the virtual obstruction but cannot pass through another area on the virtual obstruction than the transparent channel, and the virtual ray passing through the transparent channel is illuminated at a corresponding position in the virtual scene. Different transparent channels are all transparent to the virtual ray, and are corresponding positions to which the virtual ray is illuminated in the virtual scene. Because the transparent channel satisfies the arrangement rule, a position to which the virtual ray passing through each transparent channel illuminates in the virtual scene also satisfies the arrangement rule, so that the arrangement rule may be set to form a lighting effect satisfying the arrangement rule.

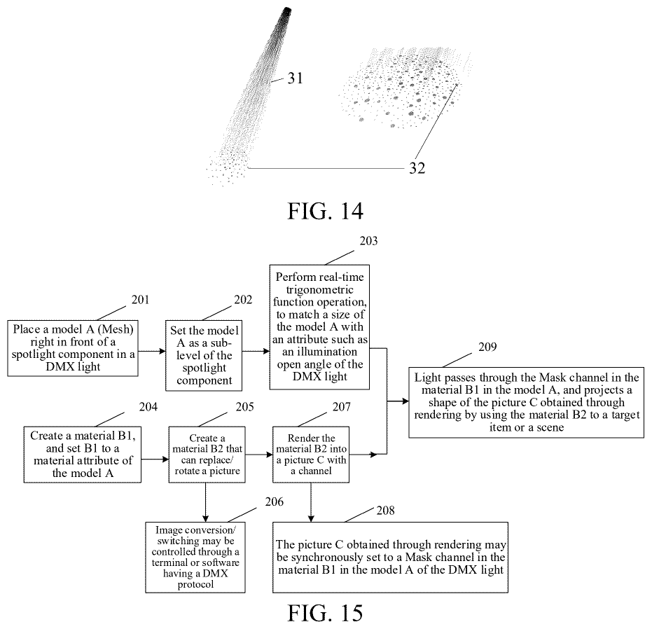

In an example, FIG. 14 is a schematic effect diagram of a virtual ray processing method according to an aspect of this disclosure. The virtual light source is controlled to illuminate the virtual obstruction at the target position, so that the virtual ray emitted by the virtual light source can pass through the transparent channel on the virtual obstruction but cannot pass through another area on the virtual obstruction than the transparent channel, and a virtual ray 31 passing through the transparent channel is illuminated at a corresponding position in the virtual scene. Different transparent channels are all transparent to the virtual ray, and are corresponding positions to which the virtual ray is illuminated in the virtual scene. Because the transparent channel satisfies the arrangement rule, a position to which the virtual ray passing through each transparent channel illuminates in the virtual scene also satisfies the arrangement rule, so that the arrangement rule may be set to form a lighting effect 32 satisfying the arrangement rule.

In this way, a light source position and a light source parameter of the virtual light source are obtained, the target size of the virtual obstruction is determined based on the light source position and the light source parameter, the virtual obstruction with the target size is generated at the target position in the virtual scene, and the virtual light source is controlled to illuminate the virtual obstruction, so that the virtual ray emitted by the virtual light source passes through the transparent channel, to form graphics satisfying the arrangement rule in the virtual scene. In this way, the virtual obstruction with the target size is placed at the target position in the virtual scene through physical parameters in the virtual scene such as the light source position and the light source parameter in the virtual scene. Because the virtual obstruction is provided with the transparent channel arranged according to the arrangement rule, the virtual obstruction placed at the target position can selectively block the virtual ray, to form the graphics satisfying the arrangement rule in the virtual scene. Through the physical parameters in the virtual scene, the placed virtual obstruction can satisfy a blocking requirement of the virtual ray, and corresponding physical parameters of the virtual scene are unchanged in different running environments, so that the placed virtual obstruction can be applicable to different running environments, thereby effectively improving universality of a running environment for processing a virtual ray.

The following describes an example application of this aspect of this disclosure in an application scenario in an actual virtual scene.

Virtual production gradually rises. Correspondingly, requirements for a virtual DMX light in the virtual production are increasingly large, and especially in virtual performance and virtual human service, the requirements are especially prominent. Pattern projection of a conventional virtual lamp uses virtual projection simulated based on an illumination function.

According to the virtual ray processing method provided in the aspects of this disclosure, a pattern projection manner can be used to project entirely based on a method of physical illumination of light in the Unreal Engine. This method is applicable to all versions. A static mesh component matching properties such as an illumination open angle of a virtual light source is produced, and a picture with a channel is set on a transparent plane of the static mesh component, to obtain a to-be-used static mesh component, and the to-be-used static mesh component is set right in front of an illumination direction of the virtual light source, so that a ray of the virtual light source can pass through each channel of the to-be-used static mesh component, to form a corresponding light effect.

In some aspects, FIG. 15 is a schematic flowchart 5 of a virtual ray processing method according to an aspect of this disclosure, and the virtual ray processing method provided in the aspects of this disclosure may be implemented by performing operation 201 to operation 209 shown in FIG. 15.

Operation 201: Place a model A (Mesh) right in front of a spotlight component in a DMX light.

In some aspects, the spotlight component in the DMX light is the virtual light source described above, the model A is the virtual obstruction described above, and the front direction is the target position described above. A virtual obstruction with a target size is generated at the target position in the virtual scene, so that the model A (Mesh) right is placed in front of the spotlight component in the DMX light.

Operation 202: Set the model A as a sub-level of the spotlight component.

In some aspects, the model A is the virtual obstruction described above. The virtual obstruction is configured to block the virtual ray emitted by the virtual light source, and the virtual ray emitted by the virtual light source cannot pass through the blocking surface of the virtual obstruction.

Operation 203: Perform real-time trigonometric function operation, to match a size of the model A with an attribute such as an illumination open angle of the DMX light.

In some aspects, through the real-time trigonometric function operation, the model A (namely, the target size of the virtual obstruction) is determined, to obtain the target length between the target position and the light source position; a connection line between the target position and the light source position is determined as a base line segment, and based on the boundary virtual ray, a target line segment perpendicular to the base line segment and intersecting with the boundary virtual ray is determined; a length value of the target line segment is determined based on the illumination open angle and the target length; and the target size of the virtual obstruction is determined based on the length value.

In some aspects, the determining a length value of the target line segment based on the illumination open angle and the target length may be implemented in the following manner: obtaining an included angle between the boundary virtual ray and the target line segment, and determining a cosine value of the included angle; obtaining a cosine value of the illumination open angle, and determining a ratio of the cosine value of the illumination open angle to the cosine value of the included angle; and determining an integer multiple of a product of the target length and the ratio as the length value of the target line segment.

Operation 204: Create a material B1, and set B1 to a material attribute of the model A.

In some aspects, the material B1 is the transparent channel map described above. When the model A is a two-dimensional virtual obstruction, the transparent channel map is arranged on a surface of the two-dimensional virtual obstruction; an area on the surface of the two-dimensional virtual obstruction coinciding with the transparent channel of each channel shape in the transparent channel map is determined as a target area; and each target area on the two-dimensional virtual obstruction is set to a transparent area, to obtain the virtual obstruction, the virtual ray emitted by the virtual light source being capable of passing through the transparent area.

Operation 205: Create a material B2 that can replace/rotate a picture.

In some aspects, the material B2 and the material B1 are transparent channel maps having different channel arrangement rules.

Operation 206: Image conversion/switching may be controlled through a terminal or software having a DMX Protocol.

In some aspects, switching between the material B1 and the material B2 may be controlled by using a terminal having the DMX protocol or software. The DMX512 is a digital dimming protocol. The DMX512 is applied for performing digital control on dimmers and other control devices in places such as a stage, a theater, and a studio. The DMX512 is applicable to a one-to-multiple-point master-slave control system. An interconnection form of the DMX512 adopts a multi-point bus structure. An information path is not blocked, and a connection line is simple and has high reliability.

Operation 207: Render the material B2 into a picture C with a channel.

Operation 208: The picture C obtained through rendering may be synchronously set to a Mask channel in the material B1 in the model A of the DMX light.

In some aspects, the transparent channel is set on the initial virtual obstruction according to the arrangement rule indicated by the transparent channel map. In other words, the picture C obtained through rendering may be synchronously set to the Mask channel in the material B1 in the model A of the DMX light, to obtain the virtual obstruction.

Operation 209: Light passes through the Mask channel in the material B1 in the model A, and projects a shape of the picture C obtained through rendering by using the material B2 to a target item or a scene.

In some aspects, a plug-in of the UE may be outputted. The plug-in includes a type of DMX virtual light inheriting ADMX Fixture Actor and a new type of DMX light is added. Compared with a native DMX light, new lights are added. A material having a Mask channel is specified for the static mesh component (named Gobo), to generate a physical projection of a light. RT Material Instance is newly added, and is configured to set and switch pattern content, render the pattern content into a Render Target, store the Render Target in a memory to be invoked for another function requiring the pattern content. When a material of the static mesh component named Gobo invokes the Render Target, the virtual light projects a physical projection at an illumination target position.

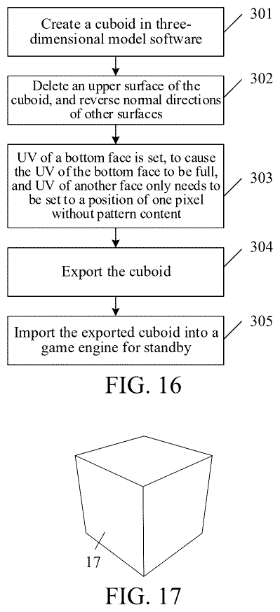

In some aspects, FIG. 16 is a schematic flowchart 6 of a virtual ray processing method according to an aspect of this disclosure, and production of the virtual obstruction may be implemented by performing operation 301 to operation 305 shown in FIG. 16.

Operation 301: Create a cuboid in three-dimensional model software.

In an example, FIG. 17 is a schematic principle diagram of a cuboid in a virtual ray processing method according to an aspect of this disclosure. A cuboid 17 is created in the three-dimensional model software. For example, a cube is created in 3D max or Maya light 3D model software, is set to 100 cm by 100 cm by 100 cm in size, and is named Gobo.

Operation 302: Delete an upper surface of the cuboid, and reverse normal directions of other surfaces.

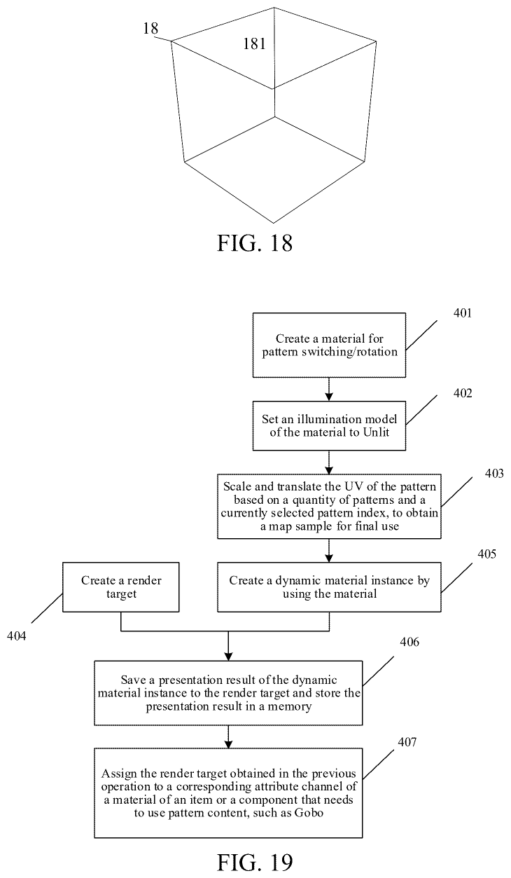

In an example, FIG. 18 is a schematic principle diagram 3 of a virtual ray processing method according to an aspect of this disclosure. An upper surface 181 of the cuboid 18 is deleted, and normal directions of other surfaces are reversed. A face above the cuboid is deleted, and normal lines of the remaining five faces are reversed. A reason why a bottom face is reserved is that in this aspect of this disclosure, a Mask is to be produced on the bottom face, so that light can be projected. A reason why a side face is reserved is that the Mesh needs to be placed close to a light source. In this way, a problem of light leakage may be caused if only one plane is used for producing the Mask. Therefore, a model of the side face is needed to block the light leakage that may occur.

Operation 303: UV of the bottom face is set, to cause the UV of the bottom face to be full, and UV of another face only needs to be set to a position of one pixel without pattern content.

In some aspects, the UV of the bottom surface is set, to cause the UV of the bottom surface to be full, and the UV of another face only needs to be set to a position of one pixel without pattern content. The reason for this is that in this aspect of this disclosure, only the bottom face needs to have a Mask and a side face does not need to have a Mask. Otherwise, in this aspect of this disclosure, there is no function of blocking the light leakage by using the Mask.

Operation 304: Export the cuboid.

In some aspects, the cuboid created in the three-dimensional model software is exported, and is imported into a game engine for standby.

Operation 305: Import the exported cuboid into the game engine for standby.

In some aspects, an imported model is placed right in front of the illumination direction of the spotlight component in the DMX light. For example, a distance is set to 10, and a rotation value of the model A (Mesh) named Gobo (when used below, a corresponding target of the name Gobo needs to be used for the model A (Mesh)) is set, so that a normal direction of a bottom face of the Gobo is consistent with a direction of the light source.

A proper size of Gobo is calculated in real time through the law of sines formula, by using a linear distance between the Mesh and the light source, and the illumination open angle of the light, and a Scale 3D attribute of Gobo is set. A reason why the function is set is because the DMX light has a Zoom attribute, and the illumination open angle of light changes. However, the size of Gobo in this aspect of this disclosure needs to be changed in real time according to a change of Zoom, so that Gobo can always block an illumination range of the light exactly.

The law of sines formula is:

$$\frac{a}{sin A} = \frac{b}{sin B} = \frac{c}{sin C} = 2 R \qquad ( 3 )$$

a is configured for indicating a side length of a side a of a triangle, A is configured for indicating a degree of an angle BAC of the triangle, b is configured for indicating a side length of a side b of the triangle, B is configured for indicating a degree of an angle ABC of the triangle, c is configured for indicating a side length of a side c of the triangle, and C is configured for indicating a degree of an angle ACB of the triangle.

In some aspects, a distance of the light source perpendicular to a bottom face of a Gobo is set as h=10 (because in this aspect of this disclosure, it has been set that the distance between the light source and the bottom face of the Gobo is 10), and because h is a height of the Gobo that is perpendicular to the bottom face of the Gobo, an angle A between h and the bottom face of the Gobo is 90°. In this case, it can be learned based on an attribute of an angle of the light that a value of ½ of Zoom of the light is B, and therefore, a degree C=90−B of a third angle of the triangle is obtained based on a feature of the right triangle. It can be deduced from the foregoing information with reference to law of sines formula that a length formula of b is as follows:

$$b = {C}^{*} sin B / sin C = 1 {0}^{*} sin B / sin ( 90 - B ) \qquad ( 4 )$$

In the Unreal Engine, a unit of scaling of an item is meter (m), and because in this aspect of this disclosure, 100 cm is used when the Mesh named Gobo is produced, that is, the side length of the Gobe is 1 m. Therefore, in this aspect of this disclosure, h needs to be divided by 100. In this case, a final length formula of b needs to be:

$$b = 10 / 10 {0}^{*} sin B / sin ( 90 - B ) \qquad ( 5 )$$

The result b obtained herein is only ½ of an illumination range when the light illuminates the distance h from the light right in front of the light at a Zoom value of 2B. In this case, a width of Gobo needs to be 2b. Therefore, a finally calculated result b needs to be multiplied by 2, and is applied to the Scale3D attribute of Gobo.

In some aspects, FIG. 19 is a schematic flowchart 7 of a virtual ray processing method according to an aspect of this disclosure, and production of a material for pattern change may be implemented by performing operation 401 to operation 407 shown in FIG. 19.

Operation 401: Create a material for pattern switching/rotation.

In some aspects, the created material is the initial virtual obstruction described above. A transparent channel is set on the initial virtual obstruction according to an arrangement rule indicated by the transparent channel map by using the created initial virtual obstruction, to obtain the virtual obstruction.

Operation 402: Set an illumination model of the material to Unlit.

In some aspects, the material does not need to receive illumination in this aspect of this disclosure. Therefore, a Shading Mode type of the material is set to Unlit; and material logic is created, and a UV of a pattern is scaled and translated based on a quantity of patterns and a currently selected pattern index, to obtain a map sample for final use.

Operation 403: Scale and translate the UV of the pattern based on the quantity of patterns and the currently selected pattern index, to obtain the map sample for final use.

Operation 404: Create a dynamic material instance by using the material.

In some aspects, a Render Target is created and named RT; and a dynamic material instance is created based on a Mat_RT material, and the dynamic material instance is named Mat_RT_Inst. The dynamic material instance Mat_RT_Inst is rendered to RT, and is stored in a memory. RT is assigned to a Texture attribute in a material used by an item that needs to present a pattern, such as Gobo, Spotlighting, and Beam. Switching between two or more patterns may be performed at the same time, that is, a pattern superimposition effect. The following describes presentation of the pattern superimposition effect.

Operation 405: Create a render target.

Operation 406: Save a presentation result of the dynamic material instance to the render target and store the presentation result in the memory.

Operation 407: Assign the render target obtained in the previous operation to a corresponding attribute channel of a material of an item or a component that needs to use pattern content, such as Gobo.

In this way, a Mask projection manner is used, so that the graphic projection manner can be implemented based on a method of physical illumination of light in the Unreal Engine and is applicable to all versions, and may also be configured for presentation of a multi-pattern superimposition effect, for example, an effect of a double pattern disk of a moving head stage light.

In this way, a light source position and a light source parameter of the virtual light source are obtained, the target size of the virtual obstruction is determined based on the light source position and the light source parameter, the virtual obstruction with the target size is generated at the target position in the virtual scene, and the virtual light source is controlled to illuminate the virtual obstruction, so that the virtual ray emitted by the virtual light source passes through the transparent channel, to form graphics satisfying the arrangement rule in the virtual scene. In this way, the virtual obstruction with the target size is placed at the target position in the virtual scene through physical parameters in the virtual scene such as the light source position and the light source parameter in the virtual scene. Because the virtual obstruction is provided with the transparent channel arranged according to the arrangement rule, the virtual obstruction placed at the target position can selectively block the virtual ray, to form the graphics satisfying the arrangement rule in the virtual scene. Through the physical parameters in the virtual scene, the placed virtual obstruction can satisfy a blocking requirement of the virtual ray, and corresponding physical parameters of the virtual scene are unchanged in different running environments, so that the placed virtual obstruction can be applicable to different running environments, thereby effectively improving universality of a running environment for processing a virtual ray.

The following continuously describe an structure of the virtual ray processing apparatus 455 provided as a software module. In some aspects, as shown in FIG. 2, the software module stored in the virtual ray processing apparatus 455 in the memory 450 may include: an obtaining module 4551, configured to obtain a light source position of a virtual light source configured to form a virtual ray in a virtual scene and a light source parameter of the virtual light source; a position determining module 4552, configured to determine a target position in the virtual scene based on the light source position, a connection line between the target position and the virtual light source coinciding with a central virtual ray, and the central virtual ray being a central virtual ray in a plurality of virtual rays emitted by the virtual light source; a size determining module 4553, configured to determine a target size of a virtual obstruction based on the light source parameter and the target position, the virtual obstruction being configured to block a virtual ray emitted by the virtual light source; a generation module 4554, configured to generate the virtual obstruction with the target size at the target position in the virtual scene, at least one transparent channel arranged according to an arrangement rule being set on the virtual obstruction; and a control module 4555, configured to control the virtual light source to illuminate the virtual obstruction, to cause a virtual ray emitted by the virtual light source to pass through the transparent channel, and form graphics satisfying the arrangement rule in the virtual scene.

In some aspects, the position determining module is further configured to obtain a plurality of virtual rays emitted by the virtual light source and a target length, the target length being less than a length of the central virtual ray; and determine the central virtual ray from the plurality of virtual rays, and determine a position on the central virtual ray with a distance from the light source position equal to the target length as the target position.

In some aspects, the light source parameter includes an illumination open angle of the virtual light source, and the illumination open angle is configured for indicating an angle between a boundary virtual ray and the central virtual ray that are emitted by the virtual light source; and the size determining module is further configured to obtain a target length between the target position and the light source position; determine a connection line between the target position and the light source position as a base line segment, and determine, based on the boundary virtual ray, a target line segment perpendicular to the base line segment and intersecting with the boundary virtual ray; determine a length value of the target line segment based on the illumination open angle and the target length; and determine the target size of the virtual obstruction based on the length value.

In some aspects, the size determining module is further configured to obtain a target line perpendicular to the base line segment, and determine an intersection point between the boundary virtual ray and the target line; and determine a line segment from the intersection point on the target line to the target position as the target line segment.

In some aspects, the size determining module is further configured to obtain an included angle between the boundary virtual ray and the target line segment, and determine a cosine value of the included angle; obtain a cosine value of the illumination open angle, and determine a ratio of the cosine value of the illumination open angle to the cosine value of the included angle; and determine an integer multiple of a product of the target length and the ratio as the length value of the target line segment.

In some aspects, the target size includes a two-dimensional target size or a three-dimensional target size; and the size determining module is further configured to determine a dimension of the virtual obstruction in response to a dimension selection operation for the virtual obstruction; and determine the two-dimensional target size of the virtual obstruction based on the length value when the dimension of the virtual obstruction is two-dimensional; or determine the three-dimensional target size of the virtual obstruction based on the length value when the dimension of the virtual obstruction is three-dimensional.

In some aspects, the size determining module is further configured to determine a shape of the virtual obstruction in response to a shape selection operation for the virtual obstruction; and when the shape of the virtual obstruction is a circle and the two-dimensional target size includes a radius of the circle, determine the length value as the radius of the circle; or when the shape of the virtual obstruction is a rectangle and the two-dimensional target size includes a side length of the rectangle, determine an integer multiple of the length value as the side length of the rectangle.

In some aspects, when the virtual obstruction is a cuboid, the three-dimensional target size includes a length, a height, and a width of the cuboid, and the size determining module is further configured to determine a first integer multiple of the length value of the target line segment as the length of the cuboid, and determine a second integer multiple of the length value of the target line segment as the width of the cuboid; obtain an illumination intensity of the virtual light source, dividing the illumination intensity by a reference illumination intensity, and determine a division result as a target multiple of the length value of the target line segment; and determine the length value of the target multiple as the height of the cuboid.

In some aspects, the generation module is further configured to obtain an initial virtual obstruction with the target size, and set, on the initial virtual obstruction, at least one transparent channel arranged according to the arrangement rule, to obtain the virtual obstruction; set the virtual obstruction at the target position in the virtual scene, a geometric center point of the virtual obstruction coinciding with the target position; and set an orientation of the virtual obstruction at the target position to a direction opposite to a direction of the central virtual ray.

In some aspects, the generation module is further configured to obtain a size type of the target size; and create a two-dimensional virtual obstruction with the two-dimensional target size when the size type is the two-dimensional target size, the virtual ray emitted by the virtual light source being incapable of passing through the two-dimensional virtual obstruction; and determine the two-dimensional virtual obstruction as the initial virtual obstruction; or create a three-dimensional virtual obstruction with the three-dimensional target size when the size type is the three-dimensional target size, the three-dimensional virtual obstruction being a polyhedron having a plurality of surfaces, and the virtual ray emitted by the virtual light source being incapable of passing through the surfaces of the polyhedron; and set any one of the surfaces of the three-dimensional virtual obstruction as a transparent surface, to obtain the initial virtual obstruction, the virtual ray emitted by the virtual light source being capable of passing through the transparent surface.

In some aspects, the generation module is further configured to obtain a transparent channel map, the transparent channel map being configured for indicating the arrangement rule of the transparent channel and a channel shape of each transparent channel, and a map size of the transparent channel map matching the target size of the virtual obstruction; and set the transparent channel on the initial virtual obstruction according to the arrangement rule indicated by the transparent channel map, to obtain the virtual obstruction.

In some aspects, when the initial virtual obstruction is the two-dimensional virtual obstruction, the generation module is further configured to arrange the transparent channel map on a surface of the two-dimensional virtual obstruction; and determine an area on the surface of the two-dimensional virtual obstruction coinciding with the transparent channel of each channel shape in the transparent channel map as a target area; and set each target area on the two-dimensional virtual obstruction to a transparent area, to obtain the virtual obstruction, the virtual ray emitted by the virtual light source being capable of passing through the transparent area.

In some aspects, when the initial virtual obstruction is the three-dimensional virtual obstruction, the three-dimensional virtual obstruction is a polyhedron, and the polyhedron includes a transparent surface, the generation module is further configured to determine a blocking surface in the three-dimensional virtual obstruction farthest from the transparent surface as the target blocking surface; and arrange the transparent channel map on the target blocking surface; determine an area on the target blocking surface coinciding with the transparent channel of each channel shape in the transparent channel map as a target area; and set each target area on the target blocking surface on the three-dimensional virtual obstruction to a transparent area, to obtain the virtual obstruction, the virtual ray emitted by the virtual light source being capable of passing through the transparent area.

A computer program product is provided, including a computer program or computer-executable instructions, and the computer program or the computer-executable instructions are stored in a computer-readable storage medium. A processor of an electronic device reads the computer-executable instructions from the computer-readable storage medium, and executes the computer-executable instructions, to enable the electronic device to perform the virtual ray processing method.

A computer-readable storage medium is provided, having computer-executable instructions stored therein, the computer-executable instructions, when executed by a processor, invoking the processor to perform the provided virtual ray processing method, for example, the virtual ray processing method shown in FIG. 3.

In some aspects, the computer-readable storage medium, such as a non-transitory computer-readable storage medium, may be a storage such as a read only memory (ROM), a random access memory (RAM), an erasable programmable read-only memory (EPROM), an electronic erasable programmable read-only memory (EEPROM), a flash memory, a magnetic surface memory, an optic disc, a CD-ROM, or the like; or may be various electronic devices including one of or any combination of the foregoing memories.

In some aspects, the computer-executable instructions may be written in a form of a program, software, a software module, a script, or code in any form of programming language (including compilation or interpretation language, or declarative or procedural language), and the computer-executable instructions may be deployed in any form, including being deployed as an independent program or being deployed as a module, component, subroutine, or another unit suitable for use in a computing environment.

In an example, the computer-executable instructions may, but do not necessarily, correspond to a file in a file system, and may be stored in a part of a file that saves another program or other data, for example, be stored in one or more scripts in a HyperText Markup Language (HTML) file, stored in a file that is specially used for a program in discussion, or stored in a plurality of collaborative files (for example, be stored in files of one or more modules, subprograms, or code parts).

In an example, the computer-executable instructions may be deployed to be executed on one electronic device, on a plurality of electronic devices located at one site, or on a plurality of electronic devices distributed at a plurality of locations and connected by a communication network.

In summary, the following beneficial effects can be achieved:

(1) A light source position and a light source parameter of a virtual light source are obtained, a target size of a virtual obstruction is determined based on the light source position and the light source parameter, the virtual obstruction with the target size is generated at a target position in a virtual scene, and the virtual light source is controlled to illuminate the virtual obstruction, so that a virtual ray emitted by the virtual light source passes through a transparent channel, to form graphics satisfying an arrangement rule in the virtual scene. In this way, the virtual obstruction with the target size is placed at the target position in the virtual scene through physical parameters in the virtual scene such as the light source position and the light source parameter in the virtual scene. Because the virtual obstruction is provided with the transparent channel arranged according to the arrangement rule, the virtual obstruction placed at the target position can selectively block the virtual ray, to form the graphics satisfying the arrangement rule in the virtual scene. The placed virtual obstruction can satisfy a blocking requirement of the virtual ray, and corresponding physical parameters of the virtual scene are unchanged in different running environments, so that the placed virtual obstruction can be applicable to different running environments, thereby effectively improving universality of a running environment for processing a virtual ray.

(2) The virtual obstruction is set to the three-dimensional virtual obstruction, and the height of the three-dimensional virtual obstruction is set to a height positively correlated with the illumination intensity of the virtual light source, so that the three-dimensional virtual obstruction of an appropriate height can block a reflected virtual ray generated through diffuse reflection of the virtual ray of the virtual light source, to effectively improve a blocking effect of the virtual obstruction.

(3) When a selected dimension of the virtual obstruction is three-dimensional, the corresponding virtual obstruction is a three-dimensional virtual obstruction. Because memory space occupation of the three-dimensional virtual obstruction in the virtual scene is larger, but compared with the two-dimensional virtual obstruction, a plurality of side surfaces are added to the three-dimensional virtual obstruction, so that the virtual ray emitted by the virtual light source can be more effectively blocked, and another virtual ray caused by diffuse reflection of the virtual ray can be effectively blocked, thereby effectively improving a ray blocking effect of the virtual obstruction.

(4) When a selected dimension of the virtual obstruction is two-dimensional, the corresponding virtual obstruction is a two-dimensional virtual obstruction. Because memory space occupation of the two-dimensional virtual obstruction in the virtual scene is less than memory space occupation of a three-dimensional virtual obstruction (in a case that an area of a bottom surface of the three-dimensional virtual obstruction is equal to an area of the two-dimensional virtual obstruction), selecting the two-dimensional virtual obstruction to block the virtual ray emitted by the virtual light source can significantly reduce memory space occupation of the virtual scene, and effectively improve processing efficiency of the virtual ray.

(5) The target position in the virtual scene is determined based on the light source position, facilitating subsequently setting a virtual obstruction at the target position, so that the virtual obstruction blocks the virtual ray emitted by the virtual light source. The manner of setting a physical obstruction in the virtual scene is applicable to various application scenarios, and can effectively improve scene universality of processing a virtual ray.

(6) A Mask projection manner is used, so that the graphic projection manner can be implemented based on a method of physical illumination of light in the Unreal Engine and is applicable to all versions, and may also be configured for presentation of a multi-pattern superimposition effect, for example, an effect of a double pattern disk of a moving head stage light.

(7) Any surface of the three-dimensional virtual obstruction is set to the transparent surface, to obtain the initial virtual obstruction, so that the virtual ray can enter inner space of the three-dimensional virtual obstruction through the transparent surface. Because the virtual ray emitted by the virtual light source cannot pass through other surfaces than the transparent surface, the virtual ray emitted by the virtual light source can be more effectively blocked, and another virtual ray caused by diffuse reflection of the virtual ray can be effectively blocked, thereby effectively improving the ray blocking effect of the virtual obstruction.

(8) When the initial virtual obstruction is the three-dimensional virtual obstruction, and the three-dimensional virtual obstruction is a polyhedron, the blocking surface on the three-dimensional virtual obstruction farthest from the transparent surface is determined as the target blocking surface. The transparent channel map is arranged on the target blocking surface. The area on the target blocking surface coinciding with the transparent channel of each channel shape in the transparent channel map is determined as the target area. Each target area on the target blocking surface on the three-dimensional virtual obstruction is set to the transparent area, to obtain the virtual obstruction, so that the virtual ray emitted by the virtual light source can pass through the transparent area. In this way, after passing through the transparent surface, the virtual ray can pass through the transparent area of the blocking surface farthest from the transparent surface, so that graphics satisfying the arrangement rule is formed in the virtual scene, thereby effectively improving the ray display effect of the virtual ray.

(9) The virtual light source is controlled to illuminate the virtual obstruction at the target position, so that the virtual ray emitted by the virtual light source can pass through the transparent channel on the virtual obstruction but cannot pass through another area on the virtual obstruction than the transparent channel, and the virtual ray passing through the transparent channel is illuminated at a corresponding position in the virtual scene. Different transparent channels are all transparent to the virtual ray, and are corresponding positions to which the virtual ray is illuminated in the virtual scene. Because the transparent channel satisfies the arrangement rule, a position to which the virtual ray passing through each transparent channel illuminates in the virtual scene also satisfies the arrangement rule, so that the arrangement rule may be set to form a lighting effect satisfying the arrangement rule.

The foregoing descriptions are merely some examples of aspects of this disclosure and are not intended to limit the scope of this disclosure. Any modification, equivalent replacement, or improvement made within the spirit and scope of this disclosure fall within the scope of this disclosure.

What is claimed is:

1. A virtual ray processing method, comprising:
obtaining a light source position of a virtual light source in a virtual scene and at least one light source parameter of the virtual light source, the virtual light source emitting a plurality of virtual rays in the virtual scene;
determining a target position in the virtual scene that is illuminated by the virtual light source based on the light source position;
determining a target size of a virtual mask based on the at least one light source parameter and the target position, the virtual mask being configured to block at least a portion of the plurality of virtual rays to generate a light pattern;
generating the virtual mask with the target size at the target position in the virtual scene, the virtual mask including at least one transparent channel arranged according to an arrangement rule; and
controlling the virtual light source to illuminate the virtual mask, a subset of the plurality of virtual rays passing through the at least one transparent channel to form the light pattern corresponding to the arrangement rule of the at least one transparent channel in the virtual mask.

2. The method according to claim 1, wherein the determining the target position comprises:
identifying, from the plurality of virtual rays, a central virtual ray of an illumination axis of the virtual light source; and
selecting, along the central virtual ray, the target position located at a target length from the light source position, the target length being calculated based on the at least one light source parameter.

3. The method according to claim 2, wherein the target length is less than a length of the central virtual ray.

4. The method according to claim 2, wherein
the at least one light source parameter comprises an illumination open angle of the virtual light source;
the illumination open angle indicates an angle between a boundary virtual ray of the plurality of virtual rays and the central virtual ray; and
the determining the target size of the virtual mask comprises:
determining a base line segment connecting the target position and the light source position;
determining, based on the boundary virtual ray, a target line segment perpendicular to the base line segment and intersecting the boundary virtual ray;
determining a length value of the target line segment based on the illumination open angle and the target length; and
determining the target size of the virtual mask based on the length value.

5. The method according to claim 4, wherein the determining the target line segment comprises:
obtaining a target line perpendicular to the base line segment;
determining an intersection point between the boundary virtual ray and the target line; and
determining, as the target line segment, a line segment extending from the intersection point to the target position.

6. The method according to claim 4, wherein the determining the length value of the target line segment comprises:
determining a first cosine value of an included angle between the boundary virtual ray and the target line segment;
determining a second cosine value of the illumination open angle;
determining a ratio of the second cosine value to the first cosine value; and
determining the length value of the target line segment based on an integer multiple of a product of the target length and the ratio.

7. The method according to claim 4, wherein the target size is one of a two-dimensional target size or a three-dimensional target size; and
the determining the target size of the virtual mask comprises:
determining a dimension of the virtual mask based on a dimension selection operation for the virtual mask;
determining the two-dimensional target size of the virtual mask based on the length value when the dimension of the virtual mask is two-dimensional; and
determining the three-dimensional target size of the virtual mask based on the length value when the dimension of the virtual mask is three-dimensional.

8. The method according to claim 7, wherein the determining the two-dimensional target size of the virtual mask comprises:
determining a shape of the virtual mask based on a shape selection operation for the virtual mask; and
determining, when the shape of the virtual mask is a circle and the two-dimensional target size includes a radius of the circle, the length value as the radius of the circle; or
determining, when the shape of the virtual mask is a rectangle and the two-dimensional target size includes a side length of the rectangle, an integer multiple of the length value as the side length of the rectangle.

9. The method according to claim 7, wherein
when the virtual mask is a cuboid, the three-dimensional target size includes a length, a height, and a width of the cuboid, and the determining the three-dimensional target size of the virtual mask comprises:
determining a first integer multiple of the length value of the target line segment as the length of the cuboid, and determining a second integer multiple of the length value of the target line segment as the width of the cuboid;
obtaining an illumination intensity of the virtual light source;
dividing the illumination intensity by a reference illumination intensity;
determining a division result as a target multiple of the length value of the target line segment; and
determining the height of the cuboid based on the length value of the target multiple.

10. The method according to claim 2, wherein the generating the virtual mask comprises:
obtaining an initial virtual mask with the target size;
forming, on the initial virtual mask, the at least one transparent channel arranged according to the arrangement rule to obtain the virtual mask;
setting a geometric center point of the virtual mask at the target position; and
setting an orientation of the virtual mask at the target position opposite to a direction of the central virtual ray.

11. The method according to claim 10, wherein the obtaining the initial virtual mask with the target size comprises:
when the target size is two-dimensional, creating a two-dimensional virtual mask with the two-dimensional target size, the plurality of virtual rays emitted by the virtual light source not passing through the two-dimensional virtual mask, and determining the two-dimensional virtual mask as the initial virtual mask; and
when the target size is three-dimensional,
creating a three-dimensional virtual mask with the three-dimensional target size, the three-dimensional virtual mask being a polyhedron having a plurality of surfaces, the plurality of virtual rays emitted by the virtual light source not passing through the plurality of surfaces of the polyhedron; and
forming one of the plurality of surfaces of the three-dimensional virtual mask as a transparent surface to obtain the initial virtual mask, the plurality of virtual rays emitted by the virtual light source not passing through the transparent surface.

12. The method according to claim 10, wherein the forming the at least one transparent channel comprises:
obtaining a transparent channel map, the transparent channel map indicating the arrangement rule for the at least one transparent channel and a channel shape of each transparent channel, a map size of the transparent channel map matching the target size of the virtual mask; and
setting the at least one transparent channel on the initial virtual mask according to the arrangement rule indicated by the transparent channel map to obtain the virtual mask.

13. The method according to claim 12, wherein when the initial virtual mask is a two-dimensional virtual mask, the setting the at least one transparent channel on the initial virtual mask comprises:
arranging the transparent channel map on a surface of the two-dimensional virtual mask;
determining, as target areas, regions of the surface of the two-dimensional virtual mask corresponding to channel shapes in the transparent channel map; and
setting each target area on the two-dimensional virtual mask to a transparent area to obtain the virtual mask, the plurality of virtual rays emitted by the virtual light source being capable of passing through the transparent area.

14. The method according to claim 12, wherein when the initial virtual mask is a three-dimensional virtual mask, the setting the at least one transparent channel on the initial virtual mask comprises:
determining, as a target blocking surface, a surface on the three-dimensional virtual mask farthest from a transparent surface;
arranging the transparent channel map on the target blocking surface;
determining, as target areas, regions on the target blocking surface corresponding to channel shapes in the transparent channel map; and
setting each target area on the target blocking surface on the three-dimensional virtual mask to a transparent area to obtain the virtual mask, the plurality of virtual rays emitted by the virtual light source being capable of passing through the transparent area.

15. A virtual ray processing apparatus, comprising:
processing circuitry configured to:
obtain a light source position of a virtual light source in a virtual scene and at least one light source parameter of the virtual light source, the virtual light source emitting a plurality of virtual rays in the virtual scene;
determine a target position in the virtual scene that is illuminated by the virtual light source based on the light source position;
determine a target size of a virtual mask based on the at least one light source parameter and the target position, the virtual mask being configured to block at least a portion of the plurality of virtual rays to generate a light pattern;
generate the virtual mask with the target size at the target position in the virtual scene, the virtual mask including at least one transparent channel arranged according to an arrangement rule; and
control the virtual light source to illuminate the virtual mask, a subset of the plurality of virtual rays passing through the at least one transparent channel to form the light pattern corresponding to the arrangement rule of the at least one transparent channel in the virtual mask.

16. The apparatus according to claim 15, wherein the processing circuitry is configured to:
identify, from the plurality of virtual rays, a central virtual ray of an illumination axis of the virtual light source; and
select, along the central virtual ray, the target position located at a target length from the light source position, the target length being calculated based on the at least one light source parameter.

17. The apparatus according to claim 16, wherein the target length is less than a length of the central virtual ray.

18. The apparatus according to claim 16, wherein the at least one light source parameter comprises an illumination open angle of the virtual light source;
the illumination open angle indicates an angle between a boundary virtual ray of the plurality of virtual rays and the central virtual ray; and
the processing circuitry is configured to:
determine a base line segment connecting the target position and the light source position;
determine, based on the boundary virtual ray, a target line segment perpendicular to the base line segment and intersecting the boundary virtual ray;
determine a length value of the target line segment based on the illumination open angle and the target length; and
determine the target size of the virtual mask based on the length value.

19. The apparatus according to claim 18, wherein the processing circuitry is configured to:
obtain a target line perpendicular to the base line segment;
determine an intersection point between the boundary virtual ray and the target line; and
determine, as the target line segment, a line segment extending from the intersection point to the target position.

20. A non-transitory computer-readable storage medium storing instructions which, when executed by a processor, cause the processor to perform:
obtaining a light source position of a virtual light source in a virtual scene and at least one light source parameter of the virtual light source, the virtual light source emitting a plurality of virtual rays in the virtual scene;
determining a target position in the virtual scene that is illuminated by the virtual light source based on the light source position;
determining a target size of a virtual mask based on the at least one light source parameter and the target position, the virtual mask being configured to block at least a portion of the plurality of virtual rays to generate a light pattern;
generating the virtual mask with the target size at the target position in the virtual scene, the virtual mask including at least one transparent channel arranged according to an arrangement rule; and
controlling the virtual light source to illuminate the virtual mask, a subset of the plurality of virtual rays passing through the at least one transparent channel to form the light pattern corresponding to the arrangement rule of the at least one transparent channel in the virtual mask.
